(19) United States
(12) Patent Application Publication
(10) Pub. No.: US 2006/0280443 A1
(43) Pub. Date: Dec. 14, 2006

(54) BROADCAST RECORDING AND REPRODUCTION APPARATUS AND METHOD THEREOF

(75) Inventor: Yuki HORII, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/420,639

(22) Filed: May 26, 2006

Related U.S. Application Data
(60) Provisional application No. 60/684,950, filed on May 27, 2005.

(51) Int. Cl. H04N 7/00

(52) U.S. Cl. 386/95

(57) ABSTRACT

A setup (a service manager 1704f or the like) for notifying a user that an application program is not executed due to a trick play in the case where the application is not executed for some reasons, during the trick play, in a synchronization interval during which the application is to be executed in synchronization with video/audio when normal reproduction is operated, and for starting the normal reproduction of a content from the start of the range within which the application is to be executed, in the case where the user desires the normal reproduction of the content during the trick play.

### CROSS REFERENCE TO RELATED APPLICATION(S)

This application claims the benefit of U.S. Provisional Application No. 60/684,950, filed May 27, 2005, the contents of which are herein incorporated by reference in its entirety.

### BACKGROUND OF THE INVENTION

(1) Field of the Invention

The present invention relates to a broadcast recording and reproduction apparatus which stores broadcast contents and reproduces the stored broadcast contents. In particular, the present invention relates to a setup for storing video, audio, and data by receiving a broadcast wave with which contents made up of video, audio, and data such as a program which are mutually synchronized are multiplexed, as well as a setup for performing trick play such as fast-forward, rewind, of the content while maintaining the synchronization of the video, audio, and data such as a program.

(2) Description of the Related Art

Various contents are included in a broadcast wave sent from a broadcast station. Aside from video and audio used in a normal TV show, there are cases where data is included in the contents. There are several methods for sending the data, which can be roughly divided into a method of sending the data chronologically and a method of repeatedly sending the data per set interval. In the former method of sending the data chronologically, for example, data that continues over the course of time is sent in sequential order. This method is suitable for sending large amounts of data over a long period of time, but there is a drawback in that data that could not be received due to timing of the send cannot be received again. On the other hand, in the later method of repeatedly sending the data at a set interval, the same data is repeatedly sent any number of times during a fixed period. This method has an advantage in that during the period when the same data is being sent, any one of the repeatedly-sent pieces of data can be received, and thus the timing of receiving is not limited. Data broadcast, represented by BML, and file sending through DSMCC data carousel are the examples of this method. It is unknown, particularly in broadcast, when a recipient will select a channel and commence reception. In the method of sending the data chronologically, when the start of reception falls behind the timing of the sending and acquisition of the data fails, the data cannot be re-acquired. Therefore, when sending data such as an application program along with video and audio in the broadcast wave, the method of repeatedly sending the data per set interval is favorable.

At present, specifications for receiving a broadcast wave that includes video, audio, and an application program and executing the application program in synchronization with video and audio, as in the above method, have been developed and are in operation. It is possible to receive the sent application program, load the application program into a terminal, and implement various extra functions by executing the application program, rather than simply viewing the video and audio. This method for sending the application program and importing the application program into the terminal is also called “downloading”. For example, a specification called Digital Video Broadcasting-Multimedia Home Platform (DVB-MHP) ETSIES201812 v1.1.1 (2003-12) has been developed in Europe, and operations according to this specification have already commenced. In addition, Open Cable Application Platform (OCAP), which provides the same specification in the cable broadcast environment in the United States, is being developed in the United States, and actual operations are set to commence. In these specifications, the application program is written in the Java language. Various Application Programming Interfaces (APIs) for tuning, graphics display, and the like are provided in the terminal, and the Java application program can control those functions by calling the APIs.

In addition, in North America, the OCAP-DVROC-SP-OCAP-DVR-I01-040524 specification, which is aimed at adding a function for recording and reproducing the contents in the OCAP specification, is being developed. With this specification, the video, audio, and the Java application program synchronized therewith are executed, which are sent as a cable television broadcast, are recorded as contents, and furthermore, are reproduced in the same manner as when the recorded contents are directly reproduced from the broadcast wave. The application program is reproduced in synchronization with the video and audio, in the same manner as direct reproduction from the broadcast wave.

Moreover, with OCAP-DVR, trick play of the contents is realized by recording broadcast contents to a high-speed random-accessible storage medium, such as a hard disk, a semiconductor memory, and the like. Here, the trick play refers to functions for reproducing the contents at an arbitrary speed, from an arbitrary position, and so on, such as fast-forward, rewind, slow-motion, pause, skip, and the like. With OCAP-DVR, the application program imported into the terminal from the broadcast wave can control the recording and trick play of the contents. In other words, APIs for recording and trick play are provided in the terminal, and the Java application program controls each function by calling those APIs.

Normally, in order that the application program is executed in synchronization with the video and audio, control information for the synchronization is already multiplexed in the broadcast wave. The application program is sequentially executed according to the synchronization control information and is terminated. Thus, it is possible to execute the application program by switching the program to an appropriate one in accordance with a specific scene of video and audio. By the way, in the case of reproducing, in a trick play mode, a content recorded by a terminal based on the OCAP-DVR or the like, it is necessary to switch the application program to an appropriate one according to the state of the trick play operation. For example, in the case where a video is switched to another video through fast-forward, the application program which is associated with the video in synchronization is also switched according to the reproduction speed of the video. In the case of reproducing the content using a skip mode, the application program synchronized with the position to start reproducing the video after the skip operation is executed, for instance.

In the case of fast-forwarding the content, the terminal, in some cases, may not be able to execute the application program through switching according to the speed of the fast-forward reproduction. Such case includes the case where it takes time to activate the application program and the timing to activate the next application program comes during the activation.

In the OCAP-DVR specification, in consideration of such case where it is difficult to execute the application program in synchronization with video and audio during the reproduction of the content in a trick play mode, a flag which executes an application program during the reproduction of the content in a trick play mode and a flag which does not execute an application program during the reproduction of the content in a trick play mode are specified. Here, such flags can be specified by a content creator for each application, and in the case where the flag which does not execute an application program during the reproduction of the content in a trick play mode is set, even the application program that is to be reproduced in a normal play mode has to be terminated during the trick play operation of the content which includes such application program. It is specified that when the reproduction of the content is returned back to a normal play mode reproduction, the application program has to be again executed in synchronization with the video and audio according to the control information.

Japanese Translation of PCT International Application No. 2003-513555 also defines “an application program with a configuration which allows the application program to be executed during the reproduction of a content in a trick play mode” and “an application program with a configuration which does not allow the application program to be executed during the reproduction of a content in a trick play mode”. In the case of “an application program with a configuration which does not allow the application program to be executed during the reproduction of a content in a trick play mode”, a system in which the application program is terminated during the reproduction of a content that includes that application, and when the trick play operation is terminated, the application is activated again, and the control information of the application that has not been detected due to the execution of the trick play mode operation is notified to the application.

### SUMMARY OF THE INVENTION

With the prescriptions defined in the OCAP-DVR specification, and the invention described in the Japanese Translation of PCT International Application No. 2003-513555, a content creator can previously specify that an application program should not be executed during the reproduction of a content in a trick play mode. Thus, even in the case where the application program cannot be executed in synchronization with video and audio due to the length of the time for activating the application, the content creator can take measure so as not to let the application be activated.

However, with the prescriptions defined in the OCAP-DVR specification, and the invention described in the Japanese Translation of PCT International Application No. 2003-513555, in the case where it is specified not to execute an application program during the reproduction of a content in a trick play mode, a problem is that an application program to be executed during the normal play operation is not executed during the trick play operation, and the viewer cannot know, during the reproduction in the trick play mode, that there is such application.

Therefore, the viewer who has operated fast-forward reproduction is not aware of the presence of the application which should normally be reproduced, and thereby loses the opportunity to execute such application.

The present invention therefore provides a mechanism of notifying the viewer that an application is not executed since a content is being reproduced in a trick play mode, in the case where an application program is not executed, due to some problem, in a synchronization interval during which the application program has to be executed in synchronization with video/audio at the time of the normal play operation. In addition, in the case where the viewer desires an execution of an application program during the reproduction in the trick play mode, the present invention also provides a mechanism to start reproducing the content in a normal play mode from the beginning of the range within which the application should be executed. The present invention aims, with such mechanisms, that the viewer can enjoy an application program synchronized with the video/audio included in a content without any application program being missed, even if the reproduction is operated in the trick play mode.

In order to solve the abovementioned problem, the present invention is a broadcast recording and reproduction apparatus which receives a broadcast wave, and records and reproduces the received broadcast wave. The broadcast wave includes one or more video information and audio information, one or more applications and application control information including information for executing the one or more applications in synchronization with reproduction of the one or more video information and audio information, and information indicating whether or not to execute the one or more applications in synchronization with trick play of the video information and the audio information. Such broadcast recording and reproduction apparatus includes: a receiving unit which receives the broadcast wave; a recording unit which records, into a recording area, the one or more video information and audio information, the one or more applications and the application control information which are included in the received broadcast wave; a video and audio reproduction unit which reproduces the video information and audio information recorded in the recording area; an application control unit which controls execution and termination of the application recorded in the recording area, in synchronization with the reproduction of the video information and the audio information, according to the application control information included in the broadcast wave recorded in the recording area; an accepting unit which accepts an instruction for trick play of the video information and audio information to be reproduced by the video and audio reproduction unit; an in-trick-play application control determination unit which judges whether or not the application to be executed in synchronization with the video information and audio information to be reproduced is to be executed during the trick play, based on the application control information, in the case where the trick play of the video information and audio information to be reproduced by the video and audio reproduction unit is detected, determines to continue the execution of the application in the case of judging that the application is to be executed during the trick play, and determines to terminate the execution of the application in the case of judging that the application is not to be executed during the trick play; and an application presence notification unit which notifies a user of a message indicating that there is an application which is judged not to be executed during the trick play, wherein in the case where the trick play of the video information and audio information to be reproduced by the video and audio reproduction unit is detected, the application control unit controls the execution of the application in accordance with the determination made by the in-trick-play application control determination unit, and the application presence notification unit notifies the user of a message indicating that there is an application which is judged not to be executed during the trick play.

The present invention can be realized not only as such broadcast recording and reproduction apparatus but also as a broadcast recording and reproduction method, a program for the broadcast recording and reproduction apparatus, and even as a computer-readable storage medium, such as a CD-ROM in which the program is stored.

According to the present invention, the broadcast recording and reproduction apparatus receives a broadcast wave, and records and reproduces the received broadcast wave, in which the broadcast wave includes one or more video information and audio information, one or more applications and application control information including information for executing the one or more applications in synchronization with reproduction of the one or more video information and audio information, and information indicating whether or not to execute the one or more applications in synchronization with trick play of the video information and the audio information. Such broadcast recording and reproduction apparatus includes: a receiving unit which receives the broadcast wave; a recording unit which records, into a recording area, the one or more video information and audio information, the one or more applications and the application control information which are included in the received broadcast wave; a video and audio reproduction unit which reproduces the video information and audio information recorded in the recording area; an application control unit which controls execution and termination of the application recorded in the recording area, in synchronization with the reproduction of the video information and the audio information, according to the application control information included in the broadcast wave recorded in the recording area; an accepting unit which accepts an instruction for trick play of the video information and audio information to be reproduced by the video and audio reproduction unit; an in-trick-play application control determination unit which judges whether or not the application to be executed in synchronization with the video information and audio information to be reproduced is to be executed during the trick play, based on the application control information, in the case where the trick play of the video information and audio information to be reproduced by the video and audio reproduction unit is detected, determines to continue the execution of the application in the case of judging that the application is to be executed during the trick play, and determines to terminate the execution of the application in the case of judging that the application is not to be executed during the trick play; and an application presence notification unit which notifies a user of a message indicating that there is an application which is judged not to be executed during the trick play, wherein in the case where the trick play of the video information and audio information to be reproduced by the video and audio reproduction unit is detected, the application control unit controls the execution of the application in accordance with the determination made by the in-trick-play application control determination unit, and the application presence notification unit notifies the user of a message indicating that there is an application which is judged not to be executed during the trick play. Thus, it is possible to realize the recording and reproduction of the application in synchronization with the video and audio, and thereby to notify the user of the end of the application.

Also, the application control information may further include application valid range information indicating a time during which the application is to be executed in synchronization with the video information and the audio information. The broadcast recording and reproduction apparatus may further include an application valid range detection unit which detects, during the reproduction or the trick play of the video information and audio information recorded in the recording area, whether or not a time has come to start executing the application, based on the application valid range information. The in-trick-play application control determination unit may further judge whether or not the application is to be executed during the trick play, based on the application control information, in the case where the application valid range detection unit detects that the time has come to start executing the application during the trick play of the video information and audio information recorded in the recording area, determine to start the execution of the application in the case of judging that the application is to be executed during the trick play, and determine not to execute the application in the case of judging that the application is not to be executed during the trick play. Thus, it is possible to notify the user of the application which has not been executed.

Also, the application control information may further include application valid range information indicating a valid range which is a time during which the application is to be executed in synchronization with the video information and audio information, and the application presence notification unit may further end the notification to the user when the valid range of the application which is determined to be terminated has come to an end. Thus, it is possible to notify the user only during the valid range of the application.

Also, the application presence notification unit may further end the notification to the user when the valid range of the application which is determined to be terminated has come to an end. Thus, it is possible to notify the user only during the valid range of the application.

Also, the application control information may further include application valid range information indicating a valid range which is a time during which the application is to be executed in synchronization with the video information and the audio information, the application presence notification unit may notify the user of a message inquiring whether or not to execute the application which is judged not to be executed during the trick play operation, from a start point of the valid range of the application. The broadcast recording and reproduction apparatus may further include a response obtainment unit which obtains a result of user's response to the message, and upon detecting the result, execute the application from the start point of the valid range of the application and reproduce the video information and audio information from the start point in synchronization with the execution of the application, when it is detected that the result obtained as the user's response to the message indicates the execution of the application from the start point of the valid range of the application. The application presence notification unit may notify of a message inquiring whether or not the application which is judged not to be executed during the trick play is to be executed from the start point of the valid range of the application. The broadcast recording and reproduction apparatus may further include a response obtainment unit which obtains a result of user's response to the message, and upon detecting the result, execute the application from the start time of the valid range of the application and reproduce the video information and audio information from the start time in synchronization with the execution of the application, when it is detected that the result obtained as the user's response to the message indicates the execution of the application from the start point of the valid range of the application. Thus, it is possible to perform skip-to-start reproduction from the start point of the application.

Also, the application presence notification unit may further display the message to the user upon the execution of the application included in the broadcast wave. Thus, it is possible to notify the user by a privileged application.

Also, the application presence notification unit may display the message to the user upon the execution of the application included in the broadcast wave. The response obtainment unit may obtain the result of user's response upon the execution of the application included in the broadcast wave. Thus, it is possible to perform the skip-to-start operation by a privileged application.

As further information about technical background to this application, the disclosure of U.S. Provisional Application No. 60/684,950, filed May 27, 2005, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram of a broadcast system according to the present invention;

FIG. 2 is an example of how to use a frequency band used in communications between a broadcast station side system and a terminal apparatus in a cable television system according to the present invention;

FIG. 3 is an example of how to use a frequency band used in communications between a broadcast station side system and a terminal apparatus in a cable television system according to the present invention;

FIG. 4 is an example of how to use a frequency band used in communications between a broadcast station side system and a terminal apparatus in a cable television system according to the present invention;

FIG. 5 is a diagram showing a structure of a TS packet predefined by MPEG-2 specifications;

FIG. 6 is a schematic diagram of an MPEG-2 transport stream

FIG. 7 is an example of division when a PES packet predefined by MPEG-2 specifications is carried in TS packets;

FIG. 8 is an example of division when an MPEG-2 section predefined by MPEG-2 specifications is carried in TS packets;

FIG. 9 is a diagram showing a structure of an MPEG-2 section predefined by MPEG-2 specifications;

FIG. 10 is an example of use of an MPEG-2 section predefined by MPEG-2 specifications;

FIG. 11 is an example of use of a PMT predefined by MPEG-2 specifications;

FIG. 12 is an example of use of a PAT predefined by MPEG-2 specifications;

FIG. 13 is a configuration example of a hardware configuration of a broadcast recording and reproduction apparatus according to the present invention;

FIG. 14 is an example of a front panel of an input unit 1310 in a hardware configuration of a terminal apparatus 1200 according to the present invention;

FIG. 15 is an example of an appearance of the broadcast recording and reproduction apparatus according to the present invention;

FIG. 16 is an example of a device connection at the time of recording, in the recording and reproduction apparatus according to the present invention;

FIG. 17 is an example of a device connection at the time of reproduction, in the recording and reproduction apparatus according to the present invention;

FIG. 18 is a diagram showing a structure of a program stored in a terminal apparatus according to the present invention;

FIG. 19 is an example of information stored in a secondary storage unit according to the present invention;

FIG. 20 is a diagram showing an internal structure of an Application Manager (AM) according to the present invention;

FIG. 21 is a schematic diagram showing details of AIT prescribed by DVB-MHP specification according to the present invention;

FIG. 22 is a schematic diagram showing a file system sent in DSMCC format according to the present invention;

FIG. 23 is an example of a record information management table according to the present invention;

FIG. 24 is an example of the screen display onto the display by the Java program suspension display unit according to the present invention;

FIG. 25 is an example of an EPG executed by a terminal apparatus according to the present invention;

FIG. 26 is an example of an EPG executed by a terminal apparatus according to the present invention;

FIG. 27 is a flowchart showing an example of the operation used in recording a service according to the present invention;

FIG. 28 is a flowchart showing an example of the operation used in reproducing a service recorded in MPEG-2 transport stream format into the secondary storage unit according to the present invention;

FIG. 29 is a flowchart showing another operational example of the operation used in reproducing the service recorded in the MPEG-2 transport stream format into the second storage unit according to the present invention;

FIG. 30 is a flowchart showing yet another operational example of the operation used in reproducing the service recorded in the MPEG-2 transport stream format into the secondary storage unit according to the present invention;

FIG. 31 is an example of an Application Information Table (AIT) according to the present invention;

FIG. 32 is a block diagram showing a general hardware configuration of the broadcast recording and reproduction apparatus according to a second embodiment of the present invention;

FIG. 33 is an example of a record information management table according to the present invention;

FIG. 34 is an example of a device connection at the time of recordings in the recording and reproduction apparatus according to the present invention; and

FIG. 35 is an example of a device connection at the time of reproduction, in the recording and reproduction apparatus according to the present invention.

### DESCRIPTION OF THE PREFERRED EMBODIMENT(S)

### First Embodiment

Hereafter, an apparatus and a method according to the first embodiment of the present invention will be described with reference to the drawings. The present invention is aimed at recording and reproduction of contents sent and received via an arbitrary medium; however, in the present embodiment, a cable television broadcast system is described as an example. In the cable television broadcast system, a broadcast recording and reproduction apparatus is generally called a terminal apparatus.

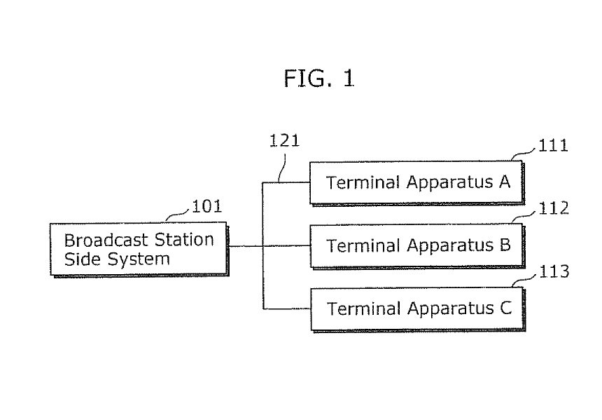

FIG. 1 is a block diagram showing a relationship of apparatuses that make up a broadcast system; the broadcast system is configured of a broadcast station side system 101 (head-end), a terminal apparatus A111, a terminal apparatus B112, and a terminal apparatus C113. A coupling 121 between the broadcast station side system and each terminal apparatus is, in the cable system, a wired coupling such as a coaxial cable, a fiber-optic cable, and the like. In FIG. 1, one broadcast station side system is coupled with three terminal apparatuses, but the number of terminal apparatuses is arbitrary.

The broadcast station side system 101 sends information such as video/audio/data for data broadcast in a broadcast signal to a plurality of terminal apparatuses. The broadcast signal is sent using a frequency within a frequency band set by operational regulations of the broadcast system and the laws of a country/region in which the broadcast system is operated, and so on.

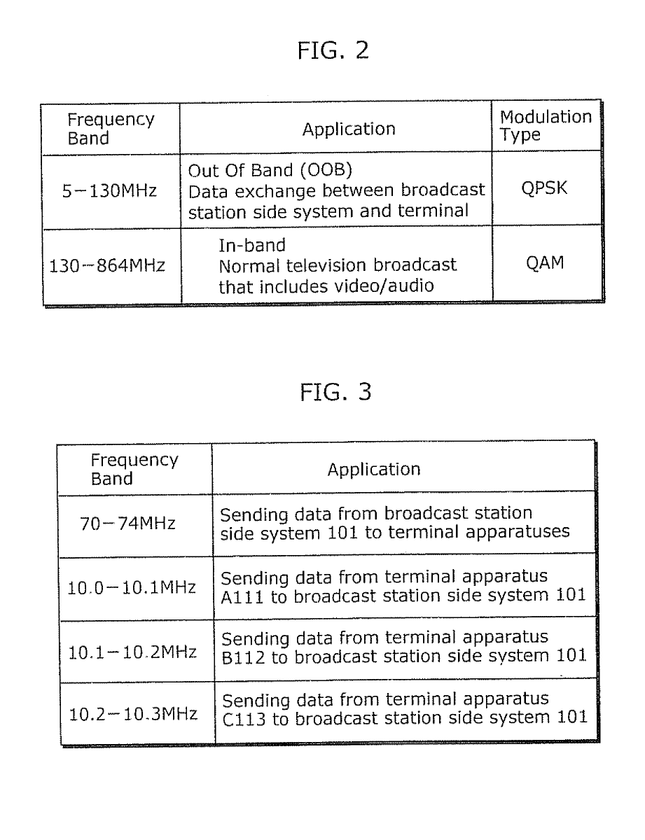

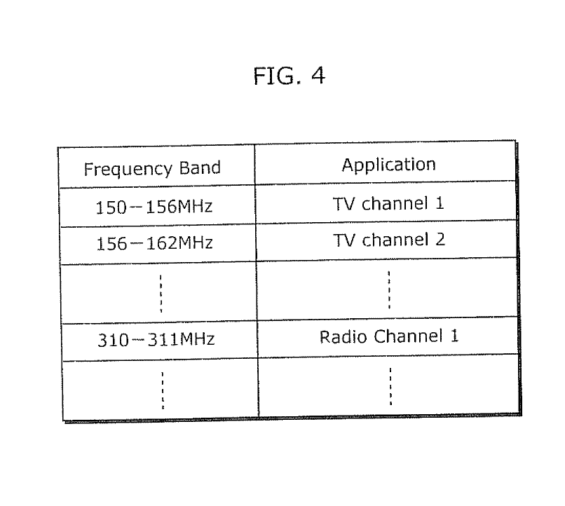

With the cable system according to the present embodiment, the frequency band used in broadcast signal transmission is divided into the data content and transmission direction (inbound, outbound) and then applied. FIG. 2 is a chart indicating one example of the division of the frequency band. The frequency band is roughly divided into two types: Out Of Band (abbr. OOB) and In-Band. 5 MHz to 130 MHz is assigned as OOB, and is mainly used in in-bound/out-band data exchange between the broadcast station side system 101 and the terminal apparatus A111, the terminal apparatus B112, and the terminal apparatus C113. 130 MHz to 864 MHz is assigned as In-Band, and is mainly used in an outbound-only broadcast channel that includes video/audio. QPSK modulation scheme is used with OOB, and QAM64 or QAM256 modulation type is used with In-Band. Modulation scheme technology is generally known and of little concern to the present invention, and therefore detailed description is omitted. FIG. 3 is one example of a more detailed use of the OOB frequency band. 70 MHz to 74 MHz is used in outbound data sending from the broadcast station side system 101, and all of the terminal apparatus A111, the terminal apparatus B112, and the terminal apparatus C113 receive the same data from the broadcast station side system 101. On the other hand, 10.0 MHz to 10.1 MHz is used in inbound data sending from the terminal apparatus A111 to the broadcast station side system 101; 10.1 MHz to 10.2 MHz is used in inbound data sending from the terminal apparatus B112 to the broadcast station side system 101; and 10.2 MHz to 10.3 MHz is used in inbound data sending from the terminal apparatus C113 to the broadcast station side system 101. Through this, it is possible to independently send unique data from each terminal apparatus A111, B112, and C113 to the broadcast station side system 101. FIG. 4 is one example of use of the In-Band frequency band. 150 MHz to 156 Mhz and 156 MHz to 162 MHz are assigned to a TV channel 1 and a TV channel 2 respectively, and thereafter, TV channels are assigned at 6 MHz intervals. Radio channels are assigned in 1 MHz units from 310 MHz on. Each of these channels may be used as analog broadcast or as digital broadcast. In the case of transmitting digital broadcast, a TS packet format based on the MPEG-2 specifications is used for the transmission, and it is also possible to send data for various data broadcast and TV show composition information for configuring EPG, in addition to audio and video.

The broadcast station side system 101 uses the frequency bands described above to send an appropriate broadcast signal to the terminal apparatuses, and therefore, has a QPSK modulation unit, a QAM modulation unit, and so on. In addition, the broadcast station side system 101 has a QPSK demodulator for receiving data from the terminal apparatuses. Moreover, the broadcast station side system 101 can be thought of as having various devices related to the modulation units and the demodulation unit. However, the present invention relates mainly to the terminal apparatuses, and therefore detailed descriptions are omitted.

The terminal apparatuses A111, B112, and C113 have a QAM demodulation unit and a QPSK demodulation unit in order to receive and reproduce a broadcast signal from the broadcast station side system 101. In addition, each terminal apparatus has a QSPK modulation unit in order to send the data unique to the apparatus to the broadcast station system side 101. In the present invention, the terminal apparatuses are broadcast recording and reproduction apparatuses, and detailed configurations will be described later.

The broadcast station side system 101 modulates an MPEG-2 transport stream and transmits the stream within the broadcast signal. The terminal apparatuses receive the broadcast signal, demodulate the broadcast signal so as to reproduce the MPEG-2 transport stream, extract necessary information wherefrom, and use the extracted information. In order to describe a device function and connection structure present in the terminal apparatus, the structure of the MPEG-2 transport stream will be first described in a simple manner.

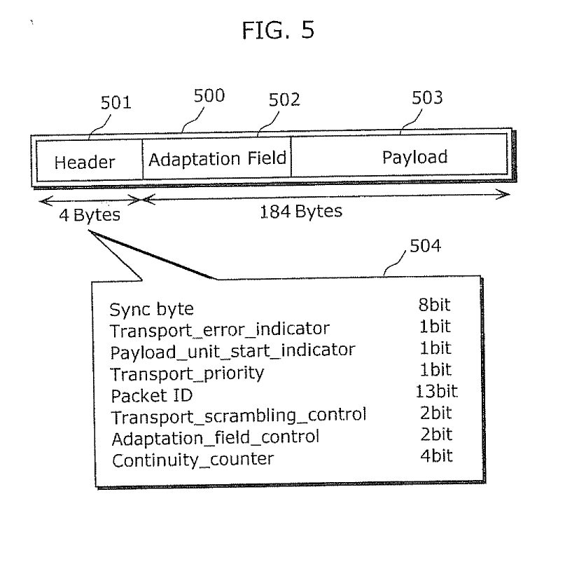

FIG. 5 is a diagram showing the structure of a TS packet. A TS packet 500 has a length of 188 bytes, and is composed of a header 501, an adaptation field 502, and a payload 503. The header 501 holds control information of the TS packet. The header 501 has a length of 4 bytes, and a structure presented by 504. In the header 501 there is a field denoted as “Packet ID” (hereafter, PID), and the TS packet is identified through the value of this PID. The adaptation field 502 holds additional information such as time information. The adaptation field 502 does not necessarily have to be present, and there are cases where the adaptation field 502 is not present. The payload 503 holds information carried in the TS packet, such as video, audio, and data broadcast data.

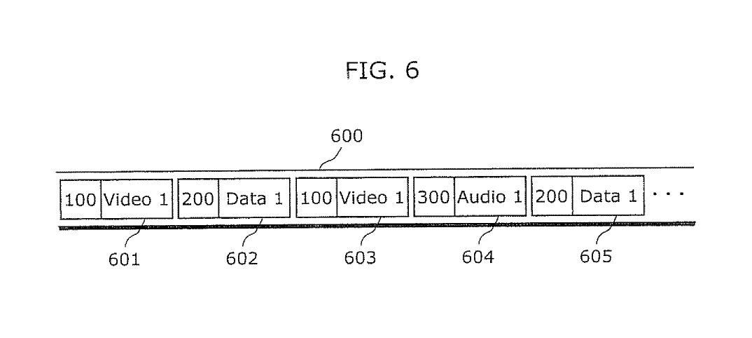

FIG. 6 is a schematic diagram of an MPEG-2 transport stream; The TS packet holds various information in the payload, such as video, audio, data used for data broadcast, alert, and the like. A TS packet 601 and a TS packet 603 hold a PID 100 in the header, and hold information regarding video 1 in the payload. A TS packet 602 and a TS packet 605 hold a PID 200 in the header, and hold information regarding data 1 in the payload A TS packet 604 holds a PID 300 in the header, and holds information regarding audio 1 in the payload. Mixing TS packets which hold various types of data in the payloads and transmitting these as a series in sequence is called multiplexing. An MPEG-2 transport stream 600 is one example of a configuration in which the TS packets 601 to 605 are multiplexed TS packets that have identical PIDs hold identical types of information. Therefore, the terminal apparatus reproduces video and audio, data such as TV show composition information, by receiving multiplexed TS packets and extracting, per PID, the information held by the TS packet. In FIG. 6, the TS packet 601 and the TS packet 603 each transmit information regarding the video 1, and the TS packet 602 and the TS packet 605 each transmit information regarding the data 1.

Here, description is given regarding a format of various types of data contained in the payload.

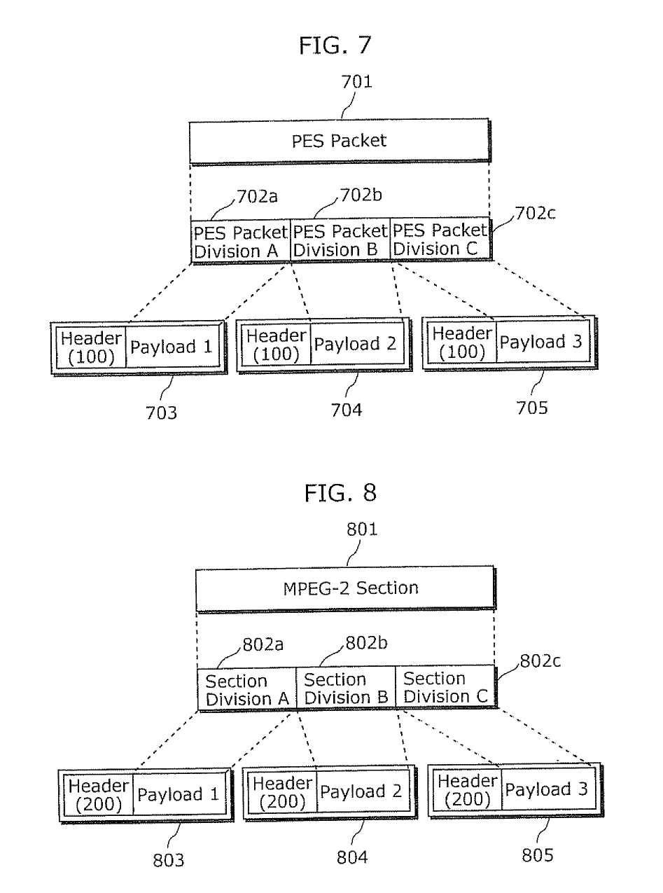

Video and audio are represented by a format called a Packetized Elementary Stream (PES) packet. The PES packet includes video information and audio information of a certain time period, and by receiving the PES packet, the broadcast recording and reproduction apparatus can output the video and audio information contained in that PES packet to a screen and a speaker. The broadcast station transmits the PES packets without pause, and therefore it is possible for the broadcast recording and reproduction apparatus to continuously reproduce the video and audio without pause. When the PES packet is actually transmitted, the PES packet is divided and stored in the payloads of a plurality of TS packets in the case where the PES packet has a size larger than the payload of one TS packet. FIG. 7 shows an example of the division when a PES packet is transmitted. A PES packet 701 is too large to be stored and transmitted in a payload of a single TS packet, and therefore the PES packet 701 is divided into a PES packet division A 702a, a PES packet division B 702b, and a PES packet division C 702c, and is carried in three TS packets 703 to 705 which have identical PIDs. In actuality, the video and audio is obtained as an elementary stream (ES) that is obtained by concatenating data contained in the payloads of a plurality of PES packets. The elementary stream is in the form of digitalized video and audio, such as defined by the MPEG-2 Video standards, the MPEG-1 and 2 Audio standards, and the like.

On the other hand, information such as the TV show composition information and data used for data broadcast is expressed using a format called MPEG-2 section. When the MPEG-2 section is actually transmitted, the MPEG-2 section is divided and stored in the payloads of a plurality of TS packets in the case where the MPEG-2 section has a size larger than the payload of one TS packet. FIG. 8 shows an example of the division when the MPEG-2 section is transmitted. As an MPEG-2 section 801 is too large to be stored and transmitted in a payload of a single TS packet, the MPEG-2 section 801 is divided into a section division A 802a, a section division B 802b, and a section division C 802c, and is carried in three TS packets 803 to 805 which have identical PIDs.

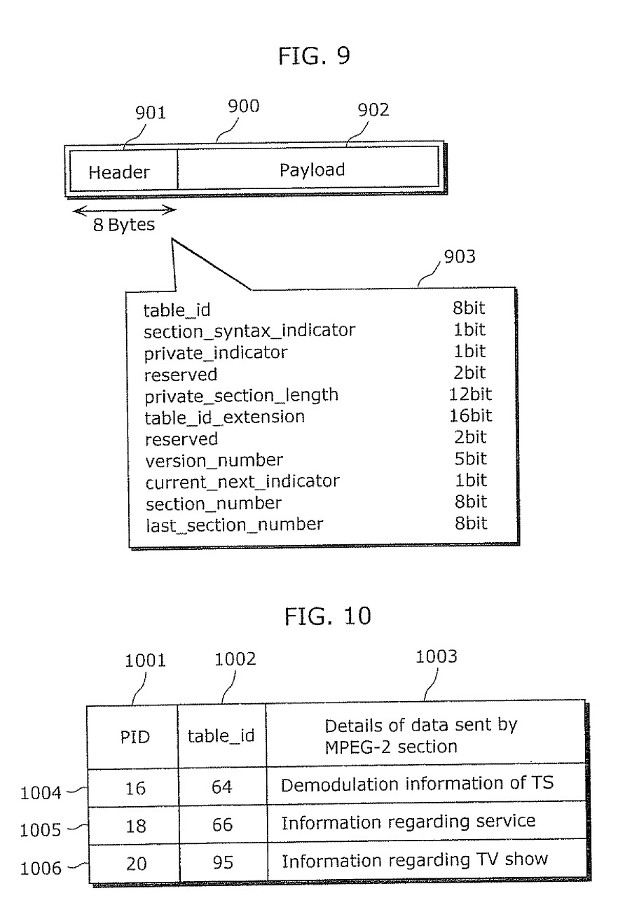

FIG. 9 presents a structure of such MPEG-2 section. An MPEG-2 section 900 is structured by a header 901 and a payload 902. The header 901 holds control information of the MPEG-2 section. The composition of the header 901 is presented by a header structure 903. The payload 902 holds data transmitted by the MPEG-2 section 900. A table_id present in the header configuration 903 represents the type of the MPEG-2 section, and a table_id_extension is an extension identifier used when further distinguishing between MPEG-2 sections, each having an identical table_id. The case of transmitting the TV show composition information is shown in FIG. 10 as an example of use of the MPEG-2 section. In this example, as written in a row 1004, information necessary for demodulation of the broadcast signal is written in the MPEG-2 section that has a table_id of 64 in the header configuration 903, and this MPEG-2 section is further transmitted by a TS packet with a PID of 16.

The PES format does not exist in the case of the MPEG-2 section. For that reason, the elementary stream (ES) is a concatenation of the payloads of the TS packets identified by the identical PIDs within the MPEG-2 transport stream. For example, in FIG. 8, all of the TS packets 803 to 805, in which the MPEG-2 section 801 is divided and transmitted, are identified with the PID of 200. It can be said that this is an ES which transmits the MPEG-2 section 801.

A concept called a program further exists in the MPEG-2 transport stream. The program is expressed as a collection of ESs, and is used in the case where handling a plurality of ESs all together is desirable. With the use of the program, it is possible to handle video/audio, as well as accompanying data broadcast data, all together. For example, in the case of handling together the video/audio to be simultaneously reproduced, by grouping the video ES and the audio ES as a program, it can be seen that the broadcast recording and reproduction apparatus should simultaneously reproduce these two ESs as one TV show.

To express the program, two tables, called a Program Map Table (PMT) and a Program Association Table (PAT) are used in MPEG-2. Detailed descriptions can be found in the specifications of ISO/IEC 13818-1, “MPEG-2 Systems”. The PMT and the PAT are briefly described hereafter.

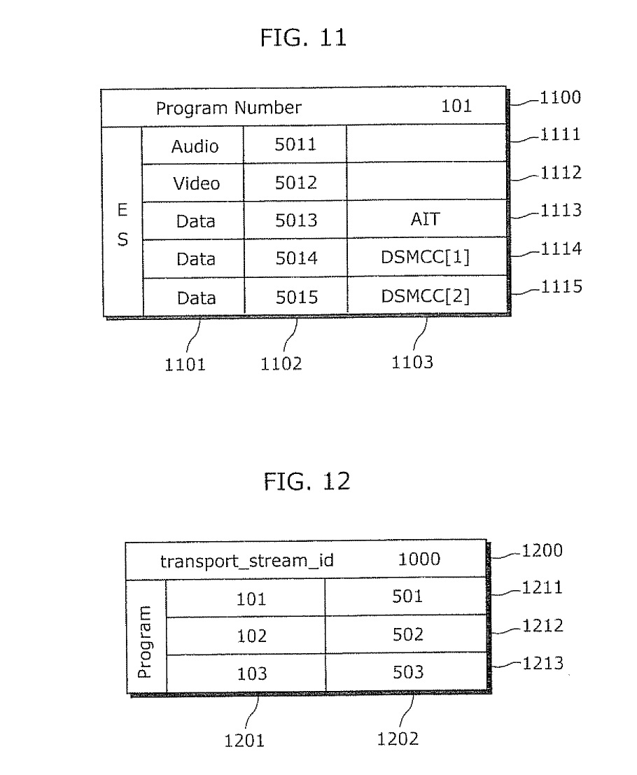

The PMT is a table included in the MPEG-2 transport stream, in a number as many as that of the program. The PMT is configured as an MPEG-2 section, and has a table_id of 2. The PMT holds a program number used in identifying the program and additional information of the program, as well as information regarding an ES belonging to the program. An example of the PMT is given in FIG. 11. 1100 is a program number. The program number is assigned uniquely to programs in the same transport stream, and is used in identifying the PMT. Rows 1111 to 1115 express information regarding individual ESs. A column 1101 is a type of ES, in which “video”, “sound”, “data”, and so on are specified. A column 1102 is the PID of the TS packets that make up the ES. A column 1103 is additional information regarding the ES. For example, the ES shown in row 1111 is an audio ES, and is carried in the TS packets with a PID of 5011.

The PAT is a table, of which only one is present, in the MPEG-2 transport stream. The PAT is configured as an MPEG-2 section, has a table_id of 0, and is carried in the TS packet with a PID of 0. The PAT holds a transport_stream_id used in identification of the MPEG-2 transport stream, and information regarding all the PMTs that represent a program in the MPEG-2 transport stream. An example of the PAT is given in FIG. 12. 1200 indicates a transport_stream_id. The transport_stream_id is used in identifying the MPEG-2 transport stream. Rows 1211 to 1213 express information regarding the program. A column 1201 indicates a program number. A column 1202 indicates the PID of the TS packet which sends the PMT that corresponds to the program. For example, the PMT of the program shown in row 1211 has a program number of 101, and the corresponding PMT is carried in the TS packet with a PID of 501.

In the case where the terminal apparatus reproduces a certain program, the terminal apparatus and specifies the video and audio that make up a program, with reference to the PAT and the PMT, and reproduces that video and audio. For example, in regards to the MPEG-2 transport stream that transmits the PAT in FIG. 12 and the PMT in FIG. 11, the following procedure is taken in the case where the video and audio belonging to the program with a program number of 101 are reproduced. First, a PAT transmitted as an MPEG-2 section with a table_id of “0” is acquired from a TS packet with a PID of “0.” The PAT is searched for a program with the program number “101”, and row 1211 is obtained. From row 1211, is the PID “501”, of the TS packet which transmits the PMT of the program with a program number “101”, is obtained. Next, the PMT transmitted as a MPEG-2 section with a table_id of “2” is acquired from the TS packet with a PID of “501”. Row 1111 which is audio ES information and row 1112 which is video ES information are obtained from the PMT. A PID “5011” of the TS packet which transmits the audio ES is obtained from row 1111. In addition, a PID “5012” of the TS packet which transmits the video ES is obtained from row 1112. Next, an audio PES packet is acquired from the TS packet with a PID “5011”, and a video PES packet is acquired from the TS packet with a PID of “5012”. Through this, it is possible to acquire the video and audio ES packets to be reproduced, and the video and audio which make up the program number 101 can be reproduced.

Note that there are cases where the MPEG-2 transport stream is scrambled. This is a setup called conditional access system. For example, by scrambling the PES packets which transmit certain video/audio information, only specified viewers who can descramble them are able to view that video and audio information. In order to descramble and view the video and audio, a viewer must descramble them using a device called a descrambler. For example, in an OCAP-compatible terminal apparatus, a card-type adapter with a built-in descrambler is used. A cable television operator distributes an adapter configured to be able to decrypt a specific program to each viewer, and the viewer inserts that adapter into the terminal apparatus. Upon doing so, the adapter descrambles the specific program based on descrambling information such as a descrambling to key and contract information of each contract holder. A method of descrambling, a method of obtaining the descrambling key, and the like, depend on the adapter, and have no influence on the realization of the present invention.

Thus far, simple descriptions regarding the MPEG-2 specifications have been provided; hereafter, detailed definitions of terminology are given. In the present invention, two types of the term “program” exist. One is a “program” which appears in the MPEG-2 specifications, and the other is a “program” referring to an assemblage of code executed by a CPU. As the former is synonymous with the term “service” used in the operation regulations, hereafter, to avoid confusion, the former is called “service” and the latter is called simply “program”. Furthermore, concerning the latter, a “program” particularly written in the Java language is called a “Java program”.

Description has been given regarding several kinds of general information specified in the MPEG-2 specifications, according to the present invention. Hereafter, a hardware configuration prerequisite to the present embodiment is described.

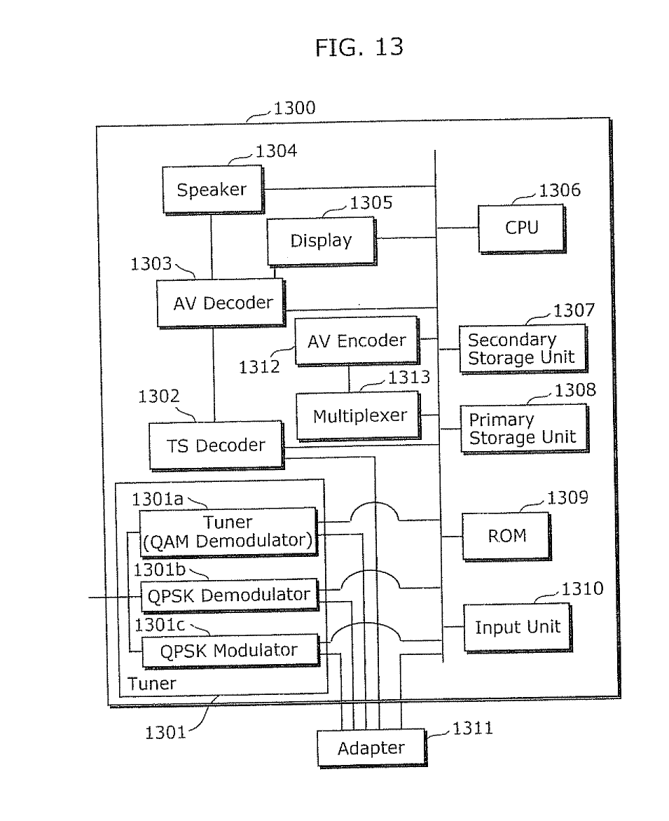

FIG. 13 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is the broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; and a multiplexer (MPEG-2 Transport Stream Multiplexer or the like) 1313. Note that the present embodiment is obtained by expanding a broadcast recording and reproduction terminal implemented by the OCAP-DVR specifications and the basic hardware configuration is nearly identical to that required by the OCAP-DVR specifications.

The tuner 1301 is a device which demodulates a broadcast signal modulated and transmitted from the broadcast station side system 101, in accordance with tuning information including a frequency prescribed by the CPU 1306. An MPEG-2 transport stream, obtained as a result of the demodulation performed by the tuner 130,1passes through the adapter 1311 that has a descrambling function, and is sent to the TS decoder 1302.

The TS decoder 1302 is a device which has a function to segregate PES packets and MPEG-2 sections which comply with specified conditions from the MPEG-2 transport stream, based on a PID, a section filter condition, and so on prescribed by the CPU 1306. In the case where a broadcast is received and a service is reproduced without recording, the MPEG-2 transport stream outputted by the adapter 1311 is inputted to the TS decoder 1302. On the other hand, in the case of reproducing a service recorded in the secondary storage unit 1307, the MPEG-2 transport stream which the secondary storage unit 1307 outputs is inputted to the TS decoder 1302. Which input to receive is controlled by the CPU 1306.

The PES packets of the video and audio segregated by the TS decoder 1302 are outputted to the AV decoder 1303. In addition, the MPEG-2 section segregated by the TS decoder 1302 is transferred to the primary storage unit 1308 through Direct Memory Access (DMA), and is used by a program executed by the CPU 1306.

The AV decoder 1303 is a device with a function to decode the encoded video ES and audio ES. The AV decoder fetches the ES from the PES packet that transmits the audio and video information sent from the TS decoder, and decodes the ES. An audio signal and a video signal obtained through the decoding performed by the AV decoder 1303 are sent to the speaker 1304 and the display 1305 at the time of service reproduction, but are sent to the AV encoder 1312 at the time of service recording. Which output route to take is controlled by the CPU 1306 according to an instruction from the user.

The speaker 1304 reproduces audio outputted from the AV decoder 1303.

The display 1305 reproduces video outputted from the AV decoder 1303.

The CPU 1306 executes a program that operates in the broadcast recording and reproduction apparatus. The CPU 1306 executes a program contained in the ROM 1309. Or, the CPU 1306 also executes a program downloaded from a broadcast signal or a network and held in the primary storage unit 1308. Or, the CPU 1306 executes a program downloaded from a broadcast signal or a network and held in the secondary storage unit 1307. The tuner 1301, TS decoder 1302, AV decoder 1303, speaker 1304, display 1305, secondary storage unit 1307, primary storage unit 1308, ROM 1309, input unit 1310, adapter 1311, AV encoder 1312 and multiplexer 1313 are controlled in accordance with the directions of the executed program. In addition, the CPU 1306 is capable of controlling the adapter 1311 by communicating not only with the devices present within the terminal apparatus 1300, but also with the devices within the adapter 1311.

The secondary storage unit 1307 is a memory apparatus, the memory of which is not deleted even if the power supply to the device is interrupted. Such secondary storage unit 1307 is configured of devices, e.g., a nonvolatile memory such as a FLASH-ROM, a Hard Disk Drive (HDD), a rewritable media such as a CD-R and a DVD-R, the information of which is not deleted even if the power supply of the terminal apparatus 1300 is cut off, The secondary storage unit 1307 saves information according to an instruction from the CPU 1306.

The primary storage unit 1308 is a device which has a function for temporarily saving information in accordance with an instruction from the CPU 1306, a DMA-transmittable device, and so on, and is configured of a RAM or the like.

The ROM 1309 is a non-rewritable memory device, and to be more specific, is configured of a ROM, a CD-ROM, a DVD, and the like. The program which the CPU 1306 executes is stored in the ROM 1309.

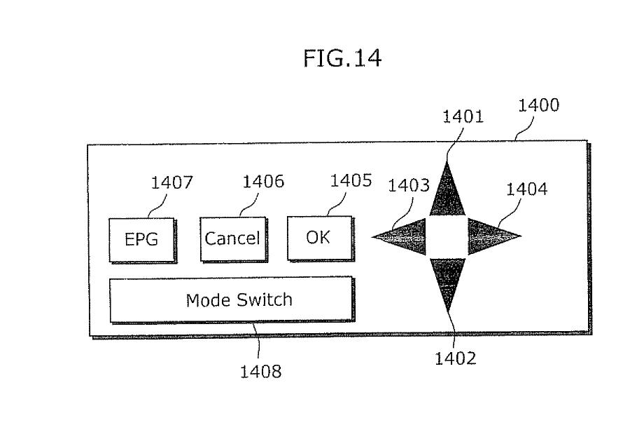

The input unit 1310 is, to be more specific, configured of a front panel or a remote control receiver, and accepts an input from the user. FIG. 14 is one example of a case where the input unit 1310 is configured of the front panel. A front panel 1400 has seven buttons: an up cursor button 1401, a down cursor button 1402, a left cursor button 1403, a right cursor button 1404, an OK button 1405, a cancel button 1406, an EPG button 1407, and a mode switch button 1408. When the user presses a button, an identifier of the pressed button is notified to the CPU 1306.

The adapter 1311 is a device for descrambling a scrambled MPEG-2 transport stream sent in the In-band frequency range, and includes one or more descramblers. The MPEG-2 transport stream outputted by the tuner 1301a is inputted into the adapter 1311, and cryptograph removal is carried out on the TS packet that has the PID specified by the CPU 1306. The adapter 1311 outputs the descrambled MPEG-2 transport stream to the TS decoder 1302.

Furthermore, the adapter 1311 carries out format conversion of data sent in an OOB frequency range. The information sent in the OOB frequency range may be modulated by the QPSK modulation scheme. Regarding outbound transmission, the QPSK demodulator 1301b demodulates the outgoing signal sent from the broadcast station side system 101, and inputs a generated bit stream into the adapter 1311. The adapter 1311 extracts information specified by the CPU 1306 from among various information included in the bit stream, converts the information to a format that can be interpreted by a program that operates in the CPU 1306, and provides this to the CPU 1306. On the other hand, regarding inbound transmission, the CPU 1306 inputs information to be sent to the broadcast station side system 101 into the adapter 1311. The adapter 1311 converts the information inputted from the CPU 1306 to a format that can be interpreted by the broadcast station side system 101, and inputs this to the QPSK modulator 1301c. The QPSK modulator 1301c QPSK-modulates the information inputted from the adapter 1311, and sends this to the broadcast station side system 101.

A Cable CARD, formerly called a Point of Deployment (POD), used in the United States cable system, can be given as a specific example of the adapter 1311.

The AV encoder 1312 encodes the audio signal decoded by the AV decoder 1303 into audio in the MPEG audio format, and encodes the video signal into video in the MPEG video format. The video and audio encoded by the AV encoder 1312 are outputted to the multiplexer 1313.

The multiplexer 1313 is a device with a function for multiplexing, with an MPEG-2 transport stream, the video and audio inputted from the AV encoder 1312 as well as an MPEG-2 section obtained from the primary storage unit.

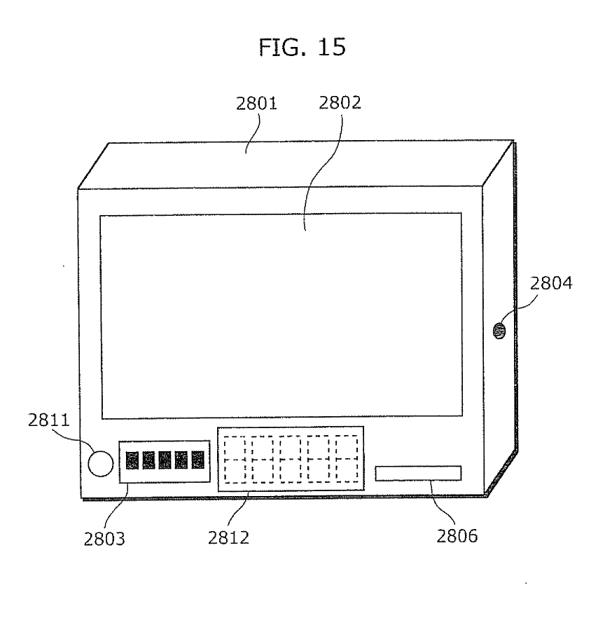

FIG. 15 is a flat-screen television (TV) that is an example of the appearance of the broadcast recording and reproduction apparatus (terminal apparatus) according to the present embodiment.

2801 is a cabinet of the flat-screen TV and all the components of the terminal apparatus except for the adapter 1313 are incorporated in the cabinet. 2802 is a display and is an equivalent of the display 1305 shown in FIG. 13. 2803 is a front panel on which plural buttons are set. 2804 is a signal input terminal and connects cable lines for sending and receiving signals to and from the broadcast station side system. The signal input terminal is connected to the tuner 1301a, the QPSK demodulator 1301b and the QPSK modulator 1301c. 2806 is an insertion slot for inserting the adapter 1311 shown in FIG. 13. 2811 is a power switch. 2812 is a sub-display such as a liquid panel.

An operation in which the broadcast recording and reproduction apparatus described above records a service contained in a broadcast wave into the secondary storage unit 1307, and an operation where the broadcast recording and receiving apparatus consecutively reads out from the secondary storage unit 1307 and reproduces the service, is hereafter described in detail.

First, the operation in which the service contained in the broadcast wave is recorded into the secondary storage unit 1307 is described.

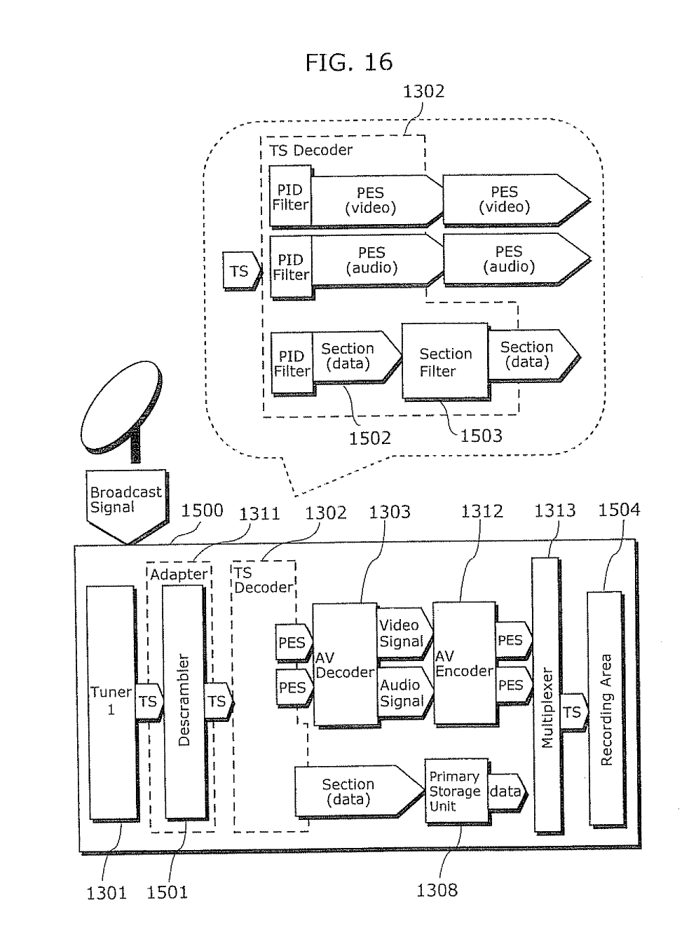

FIG. 16 shows a conceptual rendering which represents the physical connection sequence, processing details, and input/output data format of each device during recording of the service. 1500 is a terminal apparatus, which has: the tuner 1301; the adapter 1311; a descrambler 1501; the TS decoder 1302; a PID filter 1502; a section filter 1503; the AV decoder 1303; the primary storage unit 1308; the AV encoder 1312; the multiplexer 1313; and a recording area 1504. Constituent elements in FIG. 16 that have the same numbers as in FIG. 13 have the same functions and thus descriptions are omitted.

First, the tuner 1301 performs tuning on the broadcast wave in accordance with a tuning instruction prescribed by the CPU 1306. The tuner 1301 demodulates the broadcast wave and inputs the MPEG-2 transport stream into the adapter 1311.

The descrambler 1501, which is within the adapter 1311, descrambles from the MPEG-2 transport stream based on conditional access information for each viewer. The descrambled MPEG-2 transport stream is inputted into the TS decoder.

Two types of devices that process the MPEG-2 transport stream are present within the TS decoder 1302: the PID filter 1502 and the section filter 1503.

The PID filter 1502 extracts, from the inputted MPEG-2 transport stream, a TS packet that has a PID specified by the CPU 1306, and then extracts a PES packet and an MPEG-2 section present in that payload. For example, when the MPEG-2 transport stream in FIG. 6 is inputted in the case where the CPU 1306 has instructed PID filtering which extracts the TS packet with a PID=100, packets 601 and 603 are extracted, then concatenated, and thus a PES packet of a video 1 is reconfigured. Or, when the MPEG-2 transport stream in FIG. 6 is inputted in the case where the CPU 1306 has instructed PID filtering which extracts the TS packet with a PID=200, packets 602 and 605 are extracted, then concatenated, and thus an MPEG-2 section of data 1 is reconfigured.

The section filter 1503 extracts, from among the inputted MPEG-2 sections, the MPEG-2 section which conforms to a section filter condition specified by the CPU 1306 and DMA-transfers this MPEG-2 section to the primary storage unit 1308. For example, the CPU 1306 specifies, to the section filter 1503, PID filtering which extracts the TS packet with a PID=200, and section filtering which extracts a section with a table_id of 64. As mentioned earlier, after the MPEG-2 section of the data 1 is reconfigured, the section filter 1503 extracts only the section with a table_id of 64 from among those MPEG-2 sections, and DMA-transfers this to the primary storage unit 1308.

The MPEG-2 section that is inputted into the primary storage unit 1308 is inputted into the multiplexer 1313.

A video PES packet and an audio PES packet extracted by the TS decoder 1302 are inputted into the AV decoder 1303.

The AV decoder decodes the video PES packet so as to convert it into video, and inputs the video into the AV encoder 1312. The AV decoder also decodes the audio PES packet so as to convert it into audio, and inputs the audio into the AV encoder 1312.

The AV encoder 1312 converts the video into MPEG video and inputs this into the multiplexer 1313. The AV encoder 1312 also converts the audio into MPEG audio and inputs this into the multiplexer 1313.

The multiplexer 1313 multiplexes the MPEG video and MPEG audio inputted from the AV encoder, with the MPEG-2 section inputted from the primary storage unit 1308, and thus generates an MPEG-2 transport stream. The generated MPEG-2 transport stream is recorded into the recording area 1504.

The recording area 1504 is made up of all or a part of the secondary storage unit 1307, or another recording area, and records the MPEG-2 transport stream that makes up a service.

Next, an operation, in which the service is consecutively read out from the secondary storage unit 1307 and reproduced, will be described.

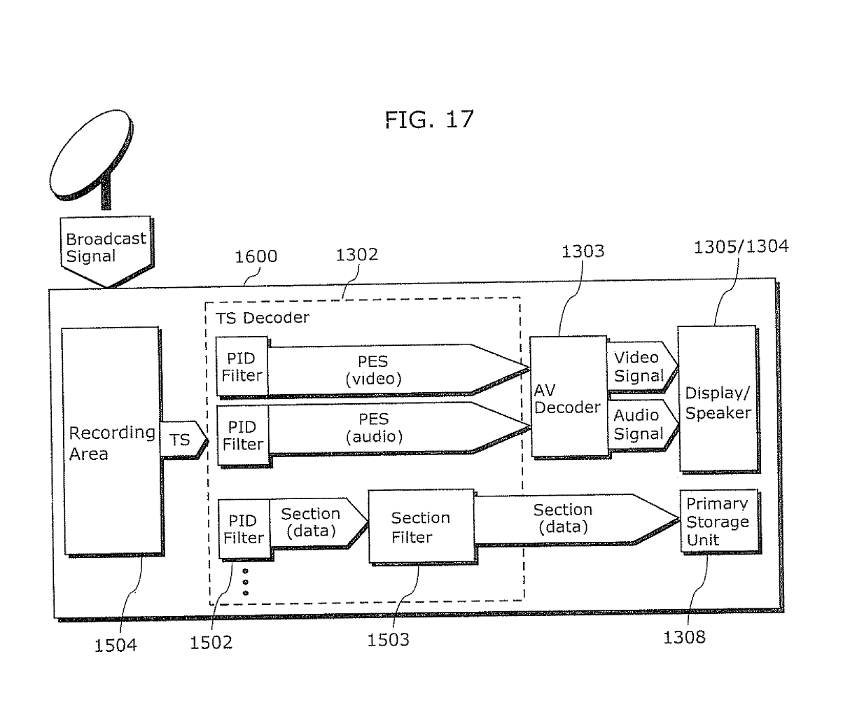

FIG. 17 shows a conceptual rendering which represents the physical connection sequence, processing details, and input/output data format of each device during reproduction of the service. 1600 is a terminal apparatus, which has: the recording area 1504; the TS decoder 1302; the PID filter 1502; the section filter 1503; the AV decoder 1303; the speaker 1304; the display 1305; and the primary storage unit 1308. Constituent elements in FIG. 17 that have the same numbers as in FIG. 13 have the same functions and thus the description is omitted.

In the order described in FIG. 16, the MPEG-2 transport stream recorded in the recording area 1504 is inputted into the TS decoder 1302.

Then, a video PES and an audio PES that have a PID specified by the CPU 1306 are extracted by the PID filter 1502 within the TS decoder 1302. The extracted PES packet is inputted into the AV decoder 1303. Or, the MPEG-2 section that has a PID and a table_id specified by the CPU 1306 is extracted by the PID filter 1502 and the section filter 1503 within the TS decoder 1302. The extracted MPEG-2 section is DMA-transferred to the primary storage unit 1308.

The video PES and the audio PES inputted into the AV decoder 1303 are decoded and outputted as an audio signal and a video signal. After that, the audio signal and the video signal are inputted into the display 1305 and the speaker 1304, thus reproducing the audio and the video.

The MPEG-2 section inputted into the primary storage unit 1308 is inputted into the CPU 1306.

Thus far, an example of a hardware configuration regarding the present invention has been described. Hereafter, a chief function of the present invention, which is control of recording the service and control of trick play, via a Java program, is described.

Recording of the service in the present invention refers to recording video, audio, a Java program, synchronization information of the Java program, and so on that are contained in the service, into a storage medium such as a hard disk, a Blu-ray Disc (BD), a Digital Versatile Disc (DVD), and a Secure Digital (SD) memory card. Reproduction of the service refers to execution and reproduction of the video, audio, and Java program recorded in the recording medium, based on the synchronization information. It is required that a reproduction result of a recorded service is almost equivalent to a result of directly reproducing the service upon receiving a broadcast wave.

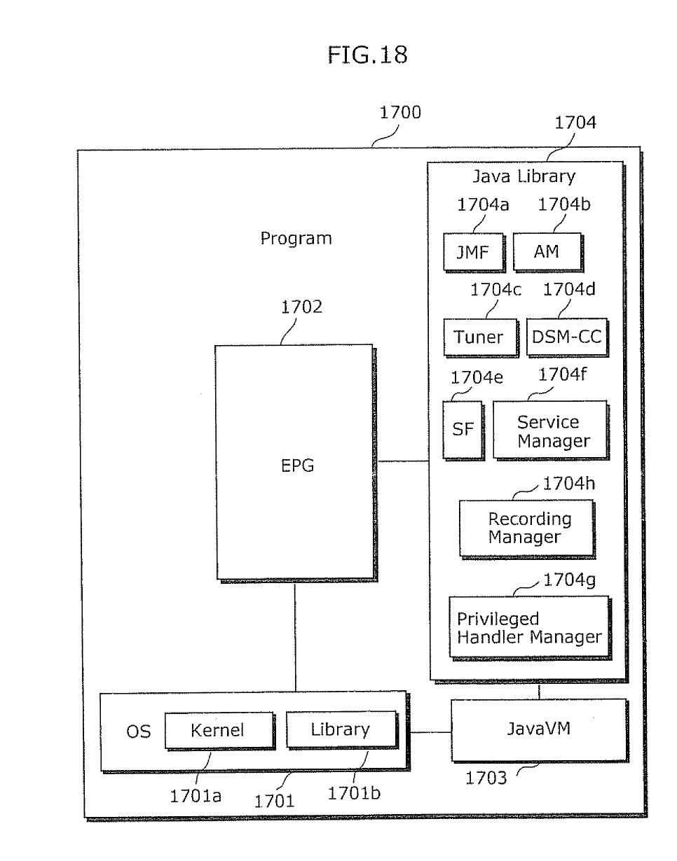

FIG. 18 is a configuration diagram of a program necessary for recording and reproduction of the service, and is software recorded in the ROM 1309.

A program 1700 is made up of an OS 1701, an EPG 1702, a Java VM 1703, and a Java library 1704, which are sub-programs.

The OS 1701 is an Operating System; Linux, Windows, and the like are examples. The OS 1701 is configured of: a kernel 1701a for executing other sub-programs such as the EPG 1702 and the Java VM 1703; and a library 1701b used by the sub-programs to control the constituent elements of the terminal apparatus 1300. The kernel 1701a is publicly-known technology and therefore the detailed description is omitted.

The library 1701b provides, for example, a tuning function for controlling a tuner. The library 1701b accepts, from another sub-program, tuning information that includes a frequency, and supplies the information to the tuner 1301. The tuner 1301 performs demodulation processing based on the provided tuning information, and can pass the demodulated MPEG-2 transport stream to the TS decoder 1302. As a result, other sub-programs can control the tuner 1301 through the library 1701b.

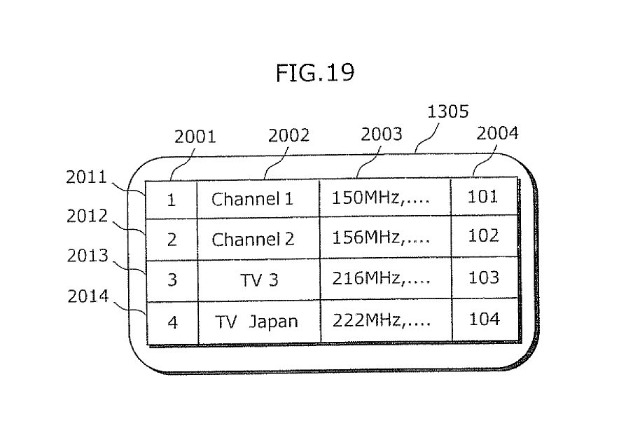

Also, the library 1701b provides channel information for uniquely identifying a channel. An example of the channel information is shown in FIG. 19. The channel information is sent using an OOB or an In-band frequency range, is converted into a chart format by the adapter 1311, and is stored in a temporary memory unit accessible by the library. A column 2001 is a channel identifier, and is equivalent to, for example, a source_ID as defined by SCTE65 Service Information Delivered Out-Of-Band For Digital Cable Television. A column 2002 is a channel name, and is equivalent to a source_name as defined by the same SCTE65 standard. A column 2003 is tuning information, and is information such as a frequency, a transfer rate, a modulation scheme, and the like that is given to the tuner 1301. A column 2004 is a program number for specifying the PMT. For example, a row 2011 is a group of service information with a channel identifier of “1”, a channel name of “channel”, a frequency of “150 MHz, . . . ” for the tuning information, and a program number of “101”.

Besides, the library 1701b can set parameters for control on the hardware configuration as shown in FIG. 13. The individual functions will be mentioned later.

The lava VM 1703 is a Java virtual machine which sequentially analyzes and executes programs written in the Java (TM) language. Programs written in the Java language are compiled of intermediate code, called bytecode, which does not depend on the hardware. The Java virtual machine is an interpreter which executes this bytecode. The Java VM 1703 executes the Java library 1704 that is written in the lava language. Details of the Java language and the Java VM are explained in publications such as “Java Language Specification” (ISBN 0-201-63451-1) and “Java Virtual Machine Specification” (ISBN 0-201-63451-X). In addition, it is possible to call or be called by other sub-programs not written in the Java language through a Java Native Interface (JNI). Details regarding the JNI can be found in a publication “Java Native Interface” and so on.

The Java library 1704 is a library written in the Java language and is called by the Java program in order to control functions of the broadcast recording and reproduction apparatus. However, there are situations where a sub-program not written in the Java language, such as the library 1701b of the OS 1701, is used as necessary. The Java program can use a function provided by the Java library 1704 by calling a Java Application Programming Interface (API) held by the Java library 1704.

A Tuner 1704c is a Java library for controlling the In-band receiving tuner 1301a of the broadcast recording and reproduction terminal. When the Java program passes tuning information to the tuner 1704c, the tuning control unit 2911uses that information to call a tuning function of the library 1701b, and as a result, it is possible to control an operation of the In-band receiving tuner 1301a of the broadcast recording and reproduction terminal.

An SF 1704e is a Java library for controlling a function of the PID filter 1502 and the section filter 1503 of the broadcast recording and reproduction terminal. When the Java program passes filter conditions such as a PID, table_id, and the like to the SF 1704e, the SF 1704e sets, based on the passed filter conditions, filtering conditions in the PID filter 1502 and the section filter 1503 using a function of the library 1701b so as to control the PID filter 1502 and the section filter 1503, acquires an MPEG-2 section that fulfills desired filter conditions, and passes the MPEG-2 section to the Java program that has set filter conditions.

A DSM-CC 1704d is a Java library for accessing a file system of a DSM-CC object carousel. The DSM-CC object carousel is included in the MPEG-2 section acquired by the SF 1704e. The DSM-CC is defined by the ISO/IEC13818-6 standard, and is a mechanism for sending an arbitrary file, using the MPEG-2 section. By using this system, it is possible to send a file from a broadcast station to a terminal. The DCM-CC 1704d obtains the MPEG-2 section using the SF 1704e, based on a file identifier specified by a Java program or the like, takes out a file based on the ISO/IEC13818-6 standards, and outputs the file. A detailed method for implementing the DSM-CC is of no relation to the present invention, and therefore details are omitted.

An AM 1704b is an application manager that provides a function for managing the execution and termination of the Java programs contained in the service. The AM 1704b extracts a Java program multiplexed onto a channel specified by a specified MPEG-2 transport stream, and causes the execution or termination of that extracted Java program in accordance with separately-multiplexed synchronization information. A Java class file of the Java program is multiplexed onto the MPEG-2 transport stream based on the aforementioned DSM-CC method. In addition, the synchronization information of the Java program is multiplexed onto the MPEG-2 transport stream in a format called AIT. AIT is an acronym of Application Information Table, as defined in chapter 10 of the DVB-MHP specification (ETSITS 101812 DVB-MHP specification V1.0.2), and is an MPEG-2 section with a table_id of “0×74”. In the present embodiment, the AIT defined by the DVB-MHP specification is modified for use.

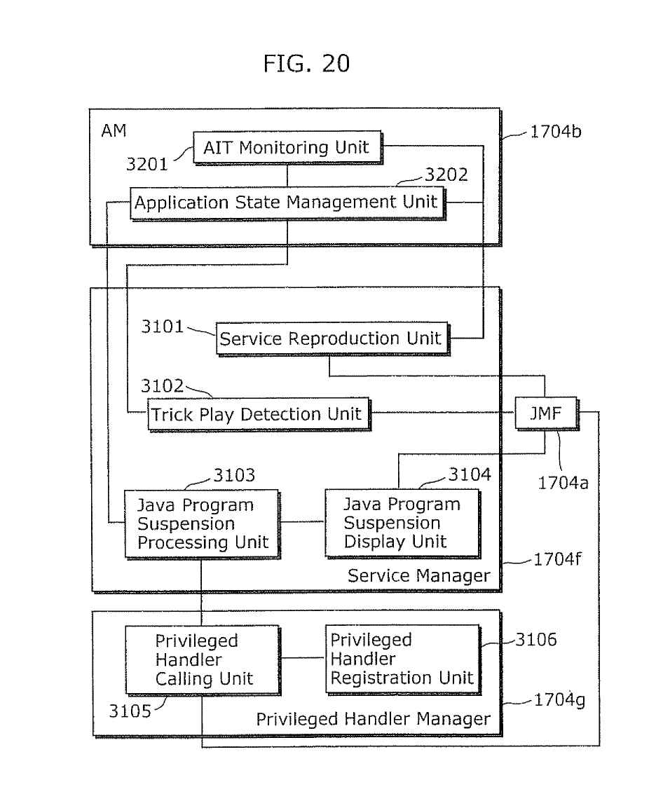

FIG. 20 shows an internal structure of the AM 1704b. The AM 1704b is configured of an AIT monitoring unit 3502 and an application status management unit 3503.

The AIT monitoring unit 3502 has an MPEG-2 transport stream and a channel identifier as inputs, and monitors the update status of the AIT. First, the AM1704b searches for channel information in the library 1701b, having a specified channel identifier as a key, and obtains the program number. Next, using the SF 1704e and the like, the PAT is acquired from the MPEG-2 transport stream. Then, the PID of a PMT that corresponds to the obtained program number is acquired from the information of the PMT. Using again the SF 1704e, the actual PMT is acquired. The acquired PMT is in the format as shown in FIG. 11, and the PIDs of elementary streams which have “data” as a stream type and “AIT” as supplementary information are written therein. When providing the SF 1704e with the PID of the obtained AIT and table_id “0×74” as the filtering conditions, the details of the AIT can be obtained.

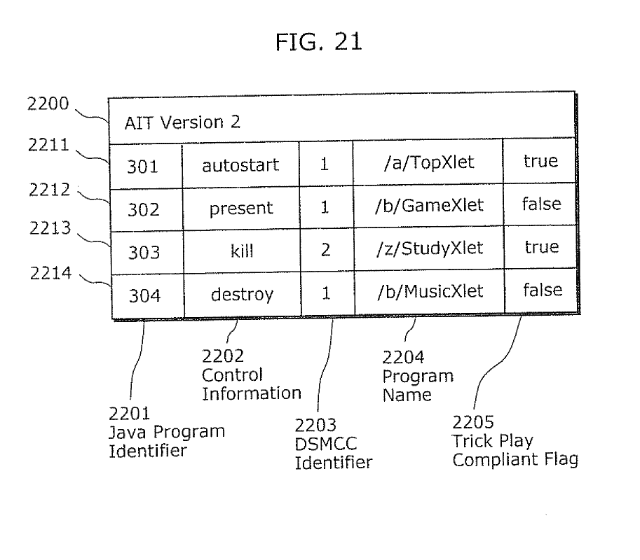

FIG. 21 is a chart that schematically shows an example of the information in the AIT. An AIT version 2200 expresses the version of that AIT. The higher the version of the AIT, the newer the AIT is. AIT of the same AIT version are repeatedly received, but the AM 1704b does not analyze AIT with the same AIT version as an AIT that has already been analyzed, and only analyzes an AIT that is newer than the already-analyzed AIT. A column 2201 is an identifier of the Java program. A column 2202 is control information of the Java program. In the control information, there is “autostart”, “present”, “kill”, and the like; “autostart” means that the terminal apparatus 1300 executes the Java program automatically in an instant, “present” means not performing automatic execution, and “kill” means stopping the Java program. A column 2203 is a DSM-CC identifier for extracting the PID that includes the Java program, based on the DS-MCC method. A column 2204 is a program name of the Java program. A column 2205 is a trick play compliant flag, and in the case where a service that includes a Java program is reproduced in a trick play mode, indicates whether or not to execute the Java program. When a trick play compliant flag indicates “true”, the Java program is reproduced even if the service that includes the Java program is being reproduced in a trick play mode. On the contrary, when a trick play compliant flag indicates “false”, the Java program is not executed while the service is reproduced in the trick play mode, and executed only during the normal play operation of the service. For example, in the case where there is a possibility of affecting the whole system due to the malfunction of the Java program included in the service, upon operating fast-forward and skip during the reproduction of the service, it is possible to prohibit the execution of the Java program during the reproduction of the service in the trick play mode by specifying the trick play compliant flag to be “false”. Rows 2211, 2212, 2213, and 2214 are groups of the information of the Java program. The Java program defined by row 2211 is a combination of a Java program identifier “301”, control information “autostart”, a DSMCC identifier “1”, and a program name “a/TopXlet”. Similarly, the Java program defined in row 2212 is a combination of a Java program identifier “302”, control information “present”, a DSMCC identifier “1”, and a program name “b/GameXlet”. Here, the three Java programs defined by rows 2211, 2212, and 2214 have the same DSMCC identifier. This indicates that three Java programs are included in one file system encoded based on the DSM-CC method. Here, four types of information are prescribed for the Java program, but in reality, more types of information are defined. Details can be found in the DVB-MHP specification.

The application status management unit 3503 analyzes the details of the updated AIT, and manages the execution state of a Java program based on the details of the AIT as well as notification of the start and end of the reproduction in the trick play mode from the service manager 1704f to be mentioned later.

The following describes the operation of managing the state of a Java program. The application status management unit 3503 finds out a Java program having the control information of “autostart” from the AIT, and extracts the corresponding DSMCC identifier and Java program name. Referring to FIG. 21 the AM 1704b extracts the Java program of the row 2211, and obtains a DSMCC identifier of “1” and a Java program name “a/TopXlet”. The AM 1704b then obtains, from the PMT, a PID of the TS packets in which the Java program is stored in DSMCC format. To be more specific, the AM 1704b obtains the PID of the elementary stream which has, within the PMT, “data” as a stream type and a DSMCC identifier that corresponds to the DSMCC identifier of the supplementary information. Here, assuming that the DSMCC identifier is “1” and the PMT is as shown in FIG. 11, the elementary stream of the row 1114 is matched and the PID “5014” is taken out.

The AM 1704b specifies the PID and the section filter conditions of the TS packets for sending the MPEG-2 section in which data is inserted based on the DSMCC method. Here, the PID “5014” is provided. As a result, the AM 1704b can collect necessary DSMCC MPEG-2 sections. The AM 1704b reconstructs the file system from the collected MPEG-2 sections according to the DSMCC method, and stores the reconstructed file system into the primary storage unit 1308. Fetching data such as the file system from the TS packets in the MPEG-2 transport stream and saving the data into a storage means such as the primary storage unit 1308 and the secondary storage unit 1307 is hereafter called downloading.

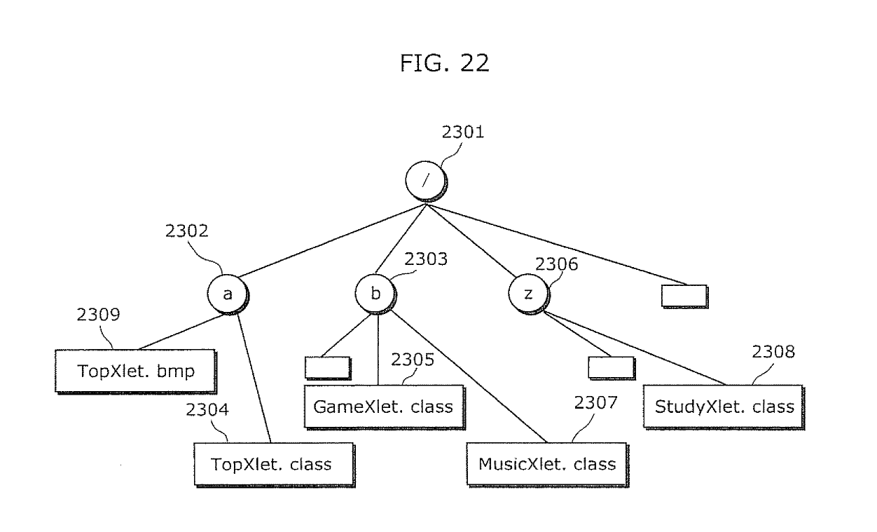

FIG. 22 is an example of a downloaded file system. In the diagram, a circle represents a directory and a square represents a file. 2301 is a root directory, 2302 is a directory “a”, 2303 is a directory “b”, 2304 is a file “TopXlet.class”, 2305 is a file “GameXlet.class”, 2306 is a directory “z”, 2307 is a file “MusicXlet.class”, and 2308 is a file “StudyXlet.class”. 2309 is an icon bitmap file “TopXlet.bmp”.

Subsequently, the AM 1704b passes, to the Java VM 1703, a Java program to be executed out of the file system downloaded into the primary storage unit 1308. Here, assuming that the Java program name to be executed is “a/TopXlet”, a file “a/TopXlet.class”, resulting from the appendage of “.class” to the above Java program name, is a file to be executed. “/” is a division between the directories and between the file names, and the file 2304 is the Java program which should be executed with reference to FIG. 22. Then, after the AM 1704b passes the file 2304 to the Java VM 1703, the file is executed as a Java program in the Java VM.

Every time an AIT with the new AIT version is inputted, the AM 1704b analyzes the AIT and changes the execution status of the Java program. Here, in the case where “kill” is specified for the control information, the AM 1704b terminates the Java program, and also, notifies the trick play instruction program judgment unit 2702 of the Java program identifier of the terminated Java program. Thus far, the Java program state management operation performed by the application status management unit has been described.

When the start of the reproduction in the trick play mode is notified from the service manager 1704f, the application status management unit 3503 thereafter performs the Java program state management operation described above only for the Java program having a trick play compliant flag of “true”. The application status management unit 3503 then kills the Java program having a trick play compliant flag of “false” and does not execute that Java program even if the control information is “autostart”. The application status management unit 3503 further notifies a Java program suspension processing unit 3103 which will be mentioned later, of the following: a Java program identifier of the Java program that has just been killed; a Java program identifier of the Java program that has not been activated, that is, the Java program having the trick play compliant flag of “false” and the control information of “autostart”; the Java program names of such Java programs; an update time (i.e. a time when the initial AIT describing the control information “autostart” for each of the Java programs is updated) of the AIT describing such Java programs; and icon bitmap files of such Java programs. The notification is performed in the case where a Java program is killed and every time the AIT is updated. The update time of the AIT is presented not by an actual time but by a media time of the MPEG-2 transport stream in which the head of the MPEG-2 transport stream stored in the secondary storage unit 1307 is defined to be “0”. The media time is a time stamp unique to the media. In the time period during which the reproduction is performed in the trick play mode, the media time may advance or delay with the speed corresponding to the reproduction in the trick play mode. Such time can be calculated based on the size of the total readout of the file and a bit rate of the MPEG-2 transport stream. For example, the media time at the time of reading 8 MB of the recorded file at the speed of 3 Mbps is 00:00:03.

On the other hand, when the end of the reproduction in the trick play is notified from the service manager 1704f, the application status management unit 3503 thereafter performs the Java program state management operation as described above for all the Java programs irrespective of a value of the trick play compliant flag. Note that in the initial state, the service is reproduced in a normal play mode; therefore, the operation is performed under the assumption that the end of the reproduction in the trick play mode has been notified.

A JMF 1704a handles control of reproduction of the video and audio contained in the service. To be more concrete, the JMF 1704a inputs the video ES and audio ES multiplexed onto the channel specified by the specified MPEG-2 transport stream into the AV decoder, so that the AV decoder reproduces them. In the case of reproducing the service directly from the received broadcast wave, it is specified that the MPEG-2 transport stream outputted from the adapter 1311 should be reproduced by the speaker 1304 and the display 1305. In the case of reproducing the service that is once recorded into the secondary storage unit 1307, it is specified that the MPEG-2 transport stream outputted from the recording area 1504 within the secondary storage unit 1307 should be reproduced by the speaker 1304 and the display 1305.

First, the JMF 1704a searches for channel information in the library 1701b with a specified channel identifier as a key, and obtains the program number. Next, using the SF 1704e and the like, the PAT is acquired from the MPEG-2 transport stream. Then, the PID of a PMT that corresponds to the obtained program number is obtained from information of the PMT. Once again, using the SF 1704e, the actual PMT is acquired. The acquired PMT is in the format as shown in FIG. 11, and the PIDs of elementary streams that have “video” and “audio” as the stream types are written therein. When the JMF 1704a sets those PIDs in the PID filter 1502 of the TS decoder 1302 through the library 1701b, the video ES and the audio ES, onto which those PIDs are multiplexed, are reproduced via the AV decoder 1303 as well as the speaker 1304 and the display 1305, as shown in FIG. 16 or FIG. 17.

In the particular case where the JMF 1704a inputs the MPEG-2 transport stream which is already recorded in the secondary storage unit, the JMF 1704a can change the reproduction speed of the video and audio by changing the speed and position of reading out the MPEG-2 transport stream. Thus, it is possible to perform trick play such as fast-forward and skip. For example, in the case where the MPEG-2 transport stream is read out at the speed twice as fast as the normal speed, the video and audio are also reproduced at the speed twice as fast as the normal speed. In the case where the position of reading out the MPEG-2 transport stream is read out after a predetermined interval is skipped, the video and audio will be reproduced with such skip. The JMF 1704a controls the secondary storage unit 1307 using the functions of the library 1701b, and changes the speed and position of reading out the MPEG-2 transport stream. The method of performing such trick play in a high level deviates from the scope of the present invention, therefore, descriptions are omitted. In order that the Java program instructs on trick play, the JMF 1704a provides the Java program with, for example, an API called setRate (float factor). The parameter “factor” presents a reproduction speed of the service, and when the parameter “factor” is specified to be 1.0, the reproduction is performed at the normal speed, whereas when the parameter “factor” is specified to be 2.0, the reproduction in the trick play mode will be performed with the speed twice as fast as the normal speed. When setRate() is called, a value of the service reproduction speed “factor” is notified to a trick play detection unit 3102 which will be mentioned later.

In addition, the JMF 1704a also provides the Java program with an API called “setPosition(int time)” for changing the position to start reproduction. A parameter “time” indicates the reproduction start position specified by the media time starting from the head of the MPEG-2 transport stream. When “setPosition()” is called, the JMF calculates the data size until the time specified based on the bit rate of the MPEG-2 transport stream, reads out, from the secondary storage unit 1307, the MPEG-2 transport stream starting from the position at which a skip mode is operated with the calculated size as offset. Thus, the service is reproduced from the specified time.

Having the channel identifier, start time, and end time inputted as inputs, the recording manager 1704h records the service into the secondary storage unit 1307, only for the period of time between the start time and the end time which are specified. For example, when the channel identifier, start time, and end time are specified by the EPG 1702, the recording manager 1704h awaits until the start time is reached. Then, when the start time is reached, the recording manager 1704h starts recording the specified service, and when the end time is reached, the recording manager 1704h terminates the recording. The details will be described below.

When the recording start time is reached, the recording manager 1704h firstly reserves, within the secondary storage unit 1307, a recording area 1504 for recording the MPEG-2 transport stream from the specified start time to the specified end time. A media identifier is supplied to the reserved recording area. Next, with the channel identifier as a key, the recording manager 1704h obtains tuning information that corresponds to the channel identifier, from the channel information held by the library 1701b. After that, when the tuning information is supplied to the Tuner 1704c, the Tuner 1704c commences tuning. Here, the tuning information is information that can specify a frequency, a modulation method, and the like. Then, as shown in FIG. 16, the MPEG-2 transport stream is inputted into the TS decoder via the adapter 1311.

Next, using the SF 1704e, the recording manager 1704h acquires the PAT from the MPEG-2 transport stream obtained through the tuning In addition, the recording manager 1704h searches for the program number that corresponds to the specified channel identifier in the library 1701b, and searches for the PID of the corresponding PMT in the PAT. After that, using the SF 1704e, the recording manager 1704h acquires an actual PMT, and obtains all the PIDs of the ESs which constitute the specified channel. The recording manager 1704h sets the obtained PIDs in the PID filter 1502 of the TS decoder. Moreover, an output destination of each hardware constituent element is set through the library 1701b so as to follow the operation of recording the service included in the broadcast wave into the secondary storage unit 1307. Then, in accordance with the flow described in FIG. 16, all of the ESs that make up a desired channel are recorded into the reserved recording area 1504.

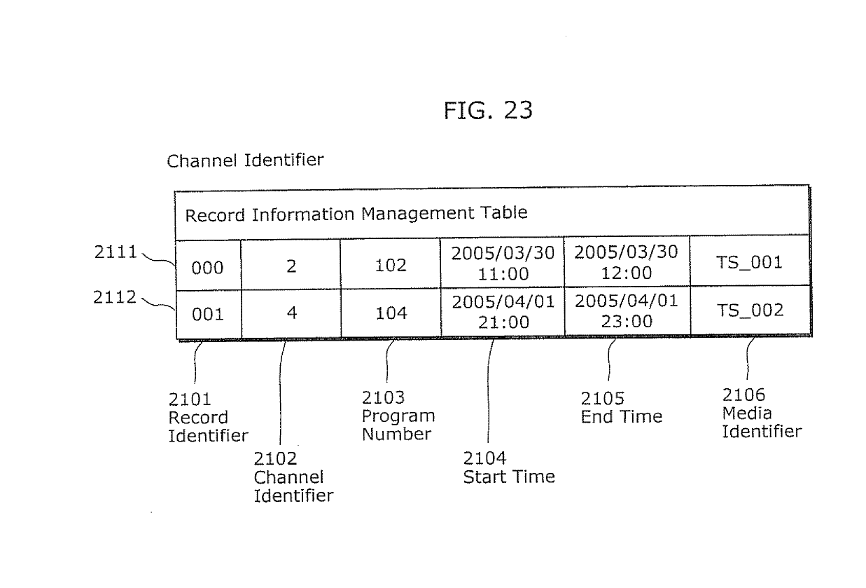

After that, when the specified end time is reached, the recording manager 1704h stops the tuning operation of the Tuner 1704c, and causes the writing of the MPEG-2 transport stream into the recording area 1504 to end. In addition, a record information management table as shown in FIG. 23 is created as management information of the MPEG-2 transport stream recorded earlier.

FIG. 23 is an example of the record information management table for managing the record information recorded into the recording area 1504 of the secondary storage unit 1307 or the like. The record information is recorded in chart format. A column 2101 indicates a record identifier. A column 2102 describes channel identifiers. A column 2103 indicates a program number. A column 2104 is the record start time for the service, and a column 2105 is the record end time for the service. A column 2106 is a media identifier which identifies the MPEG-2 transport stream that is recorded as the service. Each of rows 2111 and 2112 is a group made up of a record identifier, a channel identifier, a program number, a start time, an end time, and a media identifier. For example, row 2111 shows a record identifier of “000”, a channel identifier of “2”, a program number of “102”, a start time of “2005/03/30 11:00”, an end time of “2005/03/30 12:00”, and a media identifier of “TS_{—}001”.

A service manager 1704f manages reproduction of the service within the MPEG-2 transport stream that has been recorded into the secondary storage unit 1307, or the service within the MPEG-2 transport stream inputted from the adapter 1311. FIG. 20 shows a detailed internal structure of the service manager 1704f. The service manager 1704f is configured of a service reproduction unit 3101, a trick play detection unit 3102, a Java program suspension processing unit 3103, and a Java program suspension display unit 3104. The AM 1704b and the JMF 1704a are shown in the diagram, however, they have the same constituent elements as the constituent elements with the same referential numbers shown in FIG. 18, therefore, descriptions are omitted.

The service reproduction unit 3101 reproduces a service. Hereafter, an operation in the case of managing reproduction of the service contained in the MPEG-2 transport stream that has already been recorded in the secondary storage unit 1307 is described. This is equivalent to reproduction of an already-recorded service. In this case, the service manager 1704f has the record identifier as an input. The service which is already recorded in the secondary storage unit 1307 and is specified by that record identifier is to be reproduced.

First, referring to the record information management table created by the recording manager 1704h, the service reproduction unit 3101 obtains the channel identifier and the media identifier of the channel to be reproduced, with the specified record identifier. Then, through the library 1701b, the service manager 1704f instructs the secondary storage unit 1307 to output, to the TS decoder 1302, the MPEG-2 transport stream specified by the obtained media identifier. In addition, through the library 1701b, the service manager 1704f sets the output destination of each hardware constituent element to flow through the path shown in FIG. 17. After that, the secondary storage unit 1307 is provided to the JMF 1704a as the location of the MPEG-2 transport stream, and the channel identifier of the channel to be reproduced is provided. Then, through the operation described above, the JMF 1704a starts reproduction of the audio and video multiplexed onto the MPEG-2 transport stream outputted from the secondary storage unit 1307. After that, the secondary storage unit 1307 is provided to the JMF 1704a as the location of the MPEG-2 transport stream, and the channel identifier of the channel to be reproduced is provided. Then, in accordance with the AIT multiplexed onto the MPEG-2 transport stream outputted from the secondary storage unit 1307, the AM 1704b commences execution and termination of the Java program multiplexed onto the MPEG-2 transport stream outputted from the secondary storage unit 1307. After that, reproduction of the service is continued until the end of the MPEG-2 transport stream outputted from the secondary storage unit 1307.

On the other hand, the case of managing reproduction of the service within the MPEG-2 transport stream inputted from the adapter 1311 is described hereafter. This is equivalent to reproduction of the service directly from the broadcast wave. In this case, the service reproduction unit 3101 within the service manager 1704f has the channel identifier of the service to be reproduced as the input.

Through the library 1701b, the service reproduction unit 3101 instructs the MPEG-2 transport stream outputted from the adapter 1311 shown in FIG. 16 to be outputted to the TS decoder 1302. In addition, through the library 1701b, the service manager 1704f sets the output destination of each hardware constituent element to flow through the path shown in FIG. 17. After that, the adapter 1311 is provided to the JMF 1704a as the location of the MPEG-2 transport stream, and the channel identifier of the channel to be reproduced is provided. Then, through the operation described above, the JMF 1704a starts reproduction of the audio and video multiplexed onto the MPEG-2 transport stream outputted from the adapter 1311. Furthermore, the adapter 1311 is provided to the AM 1704b as the location of the MPEG-2 transport stream, and the channel identifier of the channel to be reproduced is provided. Then, in accordance with the AIT multiplexed onto the MPEG-2 transport stream outputted from the adapter 1311, the AM 1704b commences execution and termination of the Java program multiplexed onto the MPEG-2 transport stream outputted from the secondary storage unit 1307. After that, reproduction of the service is continued until the end of the MPEG-2 transport stream outputted from the secondary storage unit 1307.

The trick play detection unit 3102 determines the start and end of the trick play operation regarding the service which is presently being reproduced, based on the value of the service reproduction speed “factor” inputted from the JMF 1704a, and notifies the AM 1704b of the start and end of the reproduction in the trick play mode. When factor=1.0, it is judged that the reproduction is performed in a normal play mode. During the normal play operation, when a value other than 1.0 is newly inputted as “factor” by the JMF, the trick play detection unit 3102 judges that reproduction in the trick play mode is started, and notifies the application status management unit 3202 within the AM 1704b of “start of trick play operation”. During the reproduction in the trick play mode, when factor=1.0 is newly inputted from the JMF, the trick play detection unit 3102 judges that the trick play is terminated, and notifies the application status management unit 3202 within the AM 1704b of “end of trick play operation”.

The Java program suspension processing unit 3103 operates based on an input from the AM 1704b. From the AM 1704b, a Java program identifier of a Java program which is terminated or not executed, a Java program name of that Java program, an update time of the AIT in which that Java program is described and a bitmap file of that Java program are inputted. In the case of such input, the Java program suspension processing unit 3103 inputs the above information into a java program suspension display unit 3104 which will be mentioned later. Also, the abovementioned information is also inputted into a privileged handler callout unit 3105.

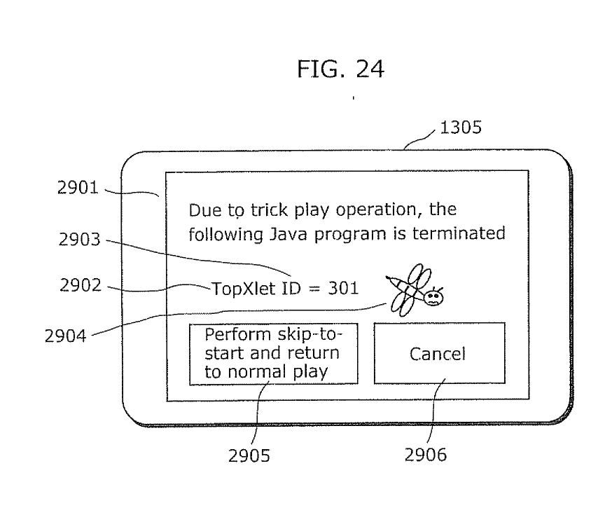

The Java program suspension display unit 3104 displays a dialog on the screen of the display 1305 based on the input of the aforementioned information from the Java program suspension processing unit 3103. FIG. 24 is an example of the dialog. A dialog 2901 is displayed on the display 1305. On the dialog 2901, a Java program which has had its execution suspended is displayed. In the example shown in FIG. 24, a Java program name 2902, a Java program identifier 2903, a Java program icon 2904, a “perform skip-to-start and return to normal play” button 2905, and a “cancel” button 2906 are displayed. The “perform skip-to-start and return to normal play” button 2905 and the “cancel” button 2906 can be selected via a remote control. When the user presses the “perform skip-to-start and return to normal play” button 2905, the Java program suspension display unit 3104 makes the dialog disappear After that, “setPosition(int time)” which is an API of the JMF 1704a is called by specifying the update time of the AIT that includes that Java program to “time”. Then, by calling “setRate(1.0)”, the reproduction speed of the service is returned to the normal speed. Thus, the reproduction of the service is re-started from the position where the AIT of the Java program which has had its execution suspended appears, and the reproduction of the service in the trick play mode is terminated to return to the normal play mode. Thus, the service is to be reproduced in the state where the Java program which has not been executed while ago is executed. In the case where the “cancel” button 2906 is pressed by the user, nothing happens but the dialog disappears.

Here, the Java program suspension display unit 3104 shall update the details of the dialog each time Java program information of the Java program which has had its execution suspended is inputted from the Java program suspension processing unit 3103. In other words, in the case where the updated new AIT does not include at all the Java program information of the program which has had its execution suspended so far, the displayed dialog will disappear.

The privileged handler manager 1704g is configured of a privileged handler callout unit 3105 and a privileged handler registration unit 3106.

The privileged handler registration unit 3106 provides the Java program with a Java API called “registerHandler (Handler h)”. When the Java program implements an arbitrary program code as a Handler class and specifies the program to a parameter h so as to call the API, the privileged handler registration unit 3106 passes that handler h to the privileged handler callout unit 3105.

The privileged handler callout unit 3105 stores the handler h passed from the privileged handler registration unit 3106 into the primary storage unit 1308. After that, when the information regarding the Java program which has had its execution suspended is inputted from the Java program suspension processing unit 3103, the privileged handler callout unit 3105 calls the handler h which has just been registered, so as to execute the program code described in the handler.

The handler h here is a Java class which has a call back method called “notify(Info i)”. “Info” is a data holding class which can hold the Java program identifier of the Java program which has been terminated or has not been executed, the Java program names of such Java programs, the update time of the AIT describing such Java programs and the icon bitmap files of such Java programs. By the fact that the privileged handler callout unit 3105 calls the call back method, the program code described in the handler h can freely execute the operation based on the information regarding the Java program which has had its execution suspended. For example, the handler h may have a program code for displaying the dialog as described in the description of the Java program suspension display unit 3104. “setRate()” and “setposition()” methods of the JMF 1704a being provided as Java APIs, it is possible for the handler h to call these methods.

The EPG 1702 is an Electric Program Guide, and is a function which lets a user choose a TV show to be recorded and reproduced. Normal play operation after receiving a broadcast wave deviates from the scope of the present invention and thus descriptions are omitted.

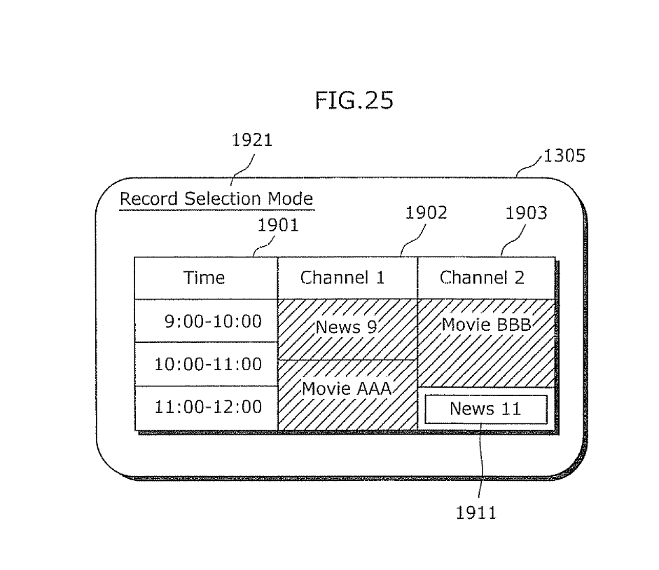

In the case of recording a TV show, the EPG 1702 displays a list of broadcasted TV shows, and lets the user choose a desired TV show. FIG. 25 is an example of a screen display for letting the user select a TV show to be recorded. A time 1901 and channels 1902 and 1903 are displayed in a grid, and it is possible to check the TV shows of each channel that is recordable at each time. It is possible for the user to move a focus 1911 within the screen by using top, bottom, right, and left cursor buttons 1401 to 1404 which are included in the input unit 1310 of the terminal apparatus 1300. Furthermore, when an OK button 1405 is pushed, the TV show which is currently highlighted is selected to be recorded. The EPG 1702 acquires the channel identifier of the TV show from the library, and when the TV show to be recorded is selected by the user, notifies the channel identifier, start time, and end time of the TV show to the recording manager 1704h. Based on that information, the recording manager 1704h records the TV show into the secondary storage unit 1307.

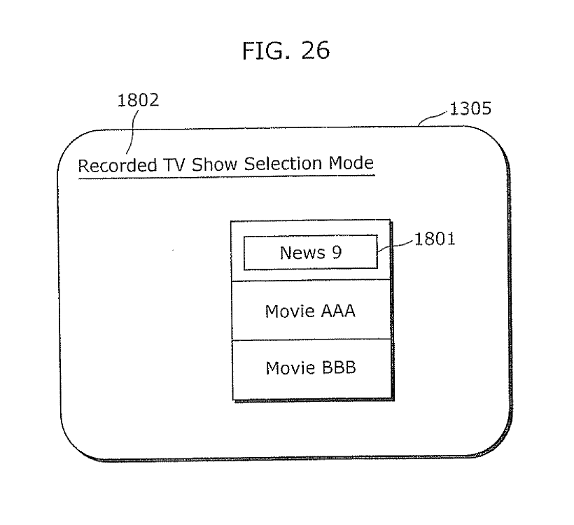

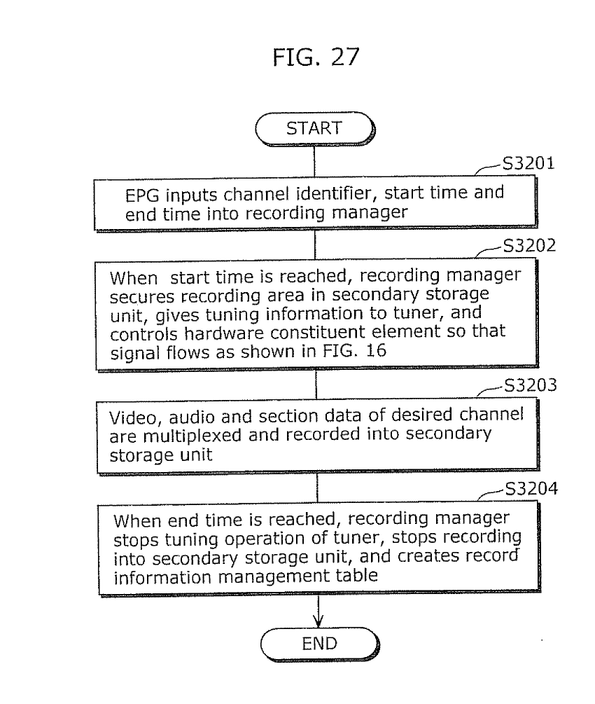

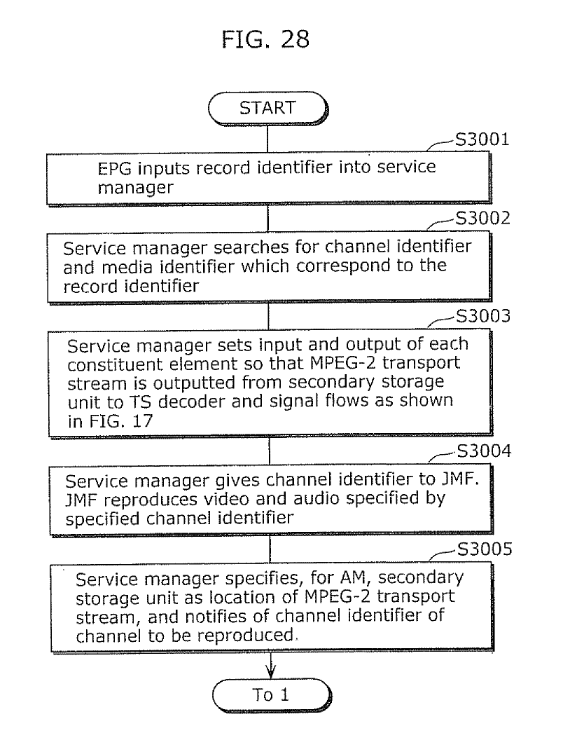

On the other hand, in the case of reproducing an already-recorded TV show, the EPG1702 displays a list of the already-recorded TV shows, and lets the user choose a desired TV show. FIG. 26 is an example of a screen display for causing selection of an already-recorded TV show. All TV shows stored in the secondary storage unit 1307 at that point in time are listed It is possible for the user to move a focus 1801 within the screen by using the top and bottom cursor buttons 1401 and 1402, which are included in the input unit 1310 of the terminal apparatus 1300. Furthermore, when the OK button 1405 is pushed, the TV show which is currently highlighted is selected to be reproduced. The EPG 1702 acquires the record identifier of the TV show from recording manager 1704h, and when the TV show to be reproduced is selected by the user, notifies the service reproduction unit 3101 within the service manager 1704f of the record identifier of that TV show. Based on that information, the service manager 1704f reads out the TV show from the secondary storage unit 1307 and reproduces it.

The operation characteristic to the broadcast recording and reproduction apparatus having the configuration as described above the present embodiment will be described below with reference to a flowchart.

FIG. 27 is a flowchart showing an example of the operation used in recording a service. When the user selects a service to be recorded, using EPG, the EPG inputs, in S3201, a channel identifier, a start time and an end time into the recording manager. Then, the recording manager waits until the start time is reached. When the start time is reached, the process moves to S3202 and the recording manager secures a recording area in the secondary storage unit, gives tuning information to a tuner, and further sets input and output of each hardware constituent element so that the signal flows as shown in FIG. 16. Then, moving onto S3203, video, audio and section data of the service selected by the EPG are multiplexed and recorded as one MPEG-2 transport stream into the secondary storage unit. After that, when the end time is reached, the recording manager stops the tuning operation of the tuner and stops the recording into the secondary storage unit. The recording manager further creates record information management table. With the operation as described above, the service selected by the EPG is recorded into the secondary storage unit.

Next, the case of reproducing the service recorded into the secondary storage unit will be described. FIGS. 28, 29 and 30 are flowcharts showing an example of the operation of reproducing the service recorded using MPEG-2 transport stream format in the secondary storage unit.

First, when selecting the recorded service to be reproduced, the EPG 1702 inputs, in S3001 in FIG. 28, a record identifier into the service reproduction unit 3101 of the service manager 1704f. Then, moving to S3002, the service reproduction unit 3101 of the service manager 1704f searches for the channel identifier and the media identifier which correspond to the record identifier. After that, in S3003, the service reproduction unit 3101 of the service manager 1704f sets input and output of each constituent element, and controls so that the MPEG-2 transport stream is outputted from the secondary storage unit to the TS decoder and the signal flows as shown in FIG. 17. In addition, in 53004, the service reproduction unit 3101 of the service manager 1704f gives the channel identifier to the JMF 1704a. Then, the process moves to S3005, and the JMF 1704a reproduces the video and audio specified by the specified channel identifier. On the other hand, in 53006, the service reproduction unit 3101 of the service manager 1704f specifies, for the AM 1704b, the secondary storage unit as the location of the MPEG-2 transport stream, and notifies of the channel identifier of the channel to be reproduced.

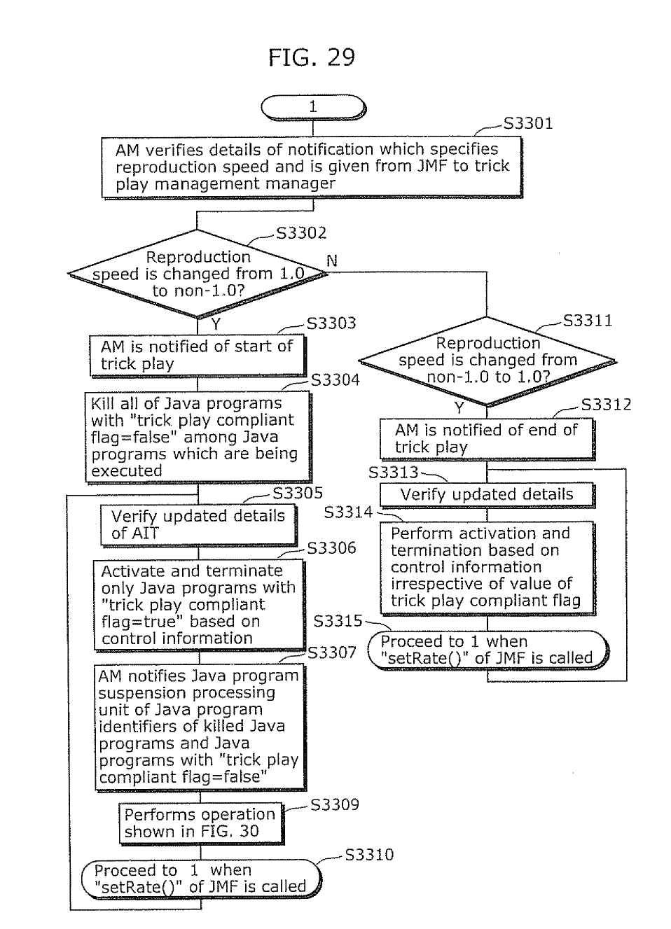

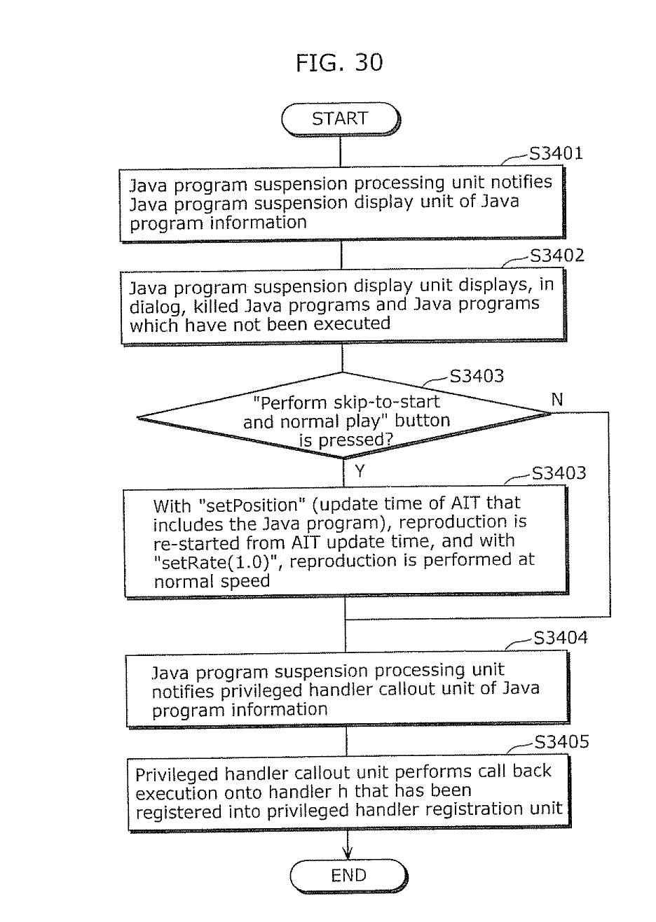

Hereafter, a process used by the AM 1704b for starting and ending a Java program is executed. FIG. 29 is a flowchart showing the operation. First, in 53301, the AM 1704b verifies the detail of notification which specifies the reproduction speed through the iS calling of “setRate()” performed by the JMF 1704a to the trick play management manager. First, in S3302, the reproduction speed has been 1.0 so far and the AM 1704b judges whether or not the speed is changed to a value other than 1.0 by calling “setRate()”. In the case where the speed is changed, the process moves to S3303, and the AM 1704b is notified of the start of the reproduction in the trick play mode. Then, in S3304, the AM 1704b kills all the Java programs with trick play compliant flag=false, among the Java programs which are being executed. In S3305, the AM 1704b verifies whether or not the AIT is updated and the updated details. Proceeding to S3306, the AM 1704b activates and terminates only the Java programs with “trick play compliant flag=true”, based on the control information in the updated AIT. Then, proceeding to S3307, the AM 1704b notifies the Java program suspension processing unit 3103 of the Java program identifiers of the killed Java programs and the Java programs with “trick play compliant flag=false”. 53309 is a operation performed by the Java program suspension processing unit 3103 and will be described with reference to FIG. 30. In S3401, the Java program suspension processing unit 3103 notifies the Java program suspension display unit 3104 of the Java program information. Moving to S3402, the Java program suspension display unit 3104 displays, in a dialog, the killed Java programs and the Java programs which have not been executed. Here, the AM 1704b judges, in S3403, whether or not the “perform skip-to-start and normal play” button is pressed, and in the case where the button is pressed, the process moves to S3404. In S3403, with the “setPosition” (update time of the AIT that includes the Java program), the reproduction is re-started from the AIT update time up to when the time is traced back, and with “setRate(1.0)”, the reproduction is performed at the normal speed. Thus, the services is again reproduced at the normal speed after tracking back to the time when the AIT is updated, therefore, the service is reproduced again in the state where the killed Java programs and the Java programs with “trick play compliant flag=false” are activated. Thus, the operation performed by the Java program suspension display unit 3104 ends, the process moves to S3404, and the operation performed by the privilege handler callout unit 3105 follows. That is to say, the Java program suspension processing unit 3103 notifies the privilege handler callout unit 3105 of the Java program information. Then, in S3405, the privilege handler callout unit 3105 performs call back execution onto the handier h that has been registered into the privilege handler registration unit 3106 in the past. In this way, an arbitrary Java program described in the handler h is executed. Here, returning to FIG. 29, when “setRate()” of the JMF is called in S3310, the process restarts from S3301. Note that in the case where the reproduction speed does not change from 1.0 to a value other than 1.0 in S3302, the process goes onto S3311. In 3311, it is judged, on the contrary, whether or not the speed indicated by a value other than 1.0 is changed back to 1.0, and in the case where the speed is changed, the process proceeds to S3312 and the AM 1704b is notified of the end of the reproduction in the trick play mode. After that, the updated details of the AIT is verified in S3313, and the activation and termination of the Java program is controlled, in S3314, based on the control information irrespective of the value of the trick play compliant flag. Then, in S3315, when “setRate()” of the JMF is called, the process restarts from S3301.

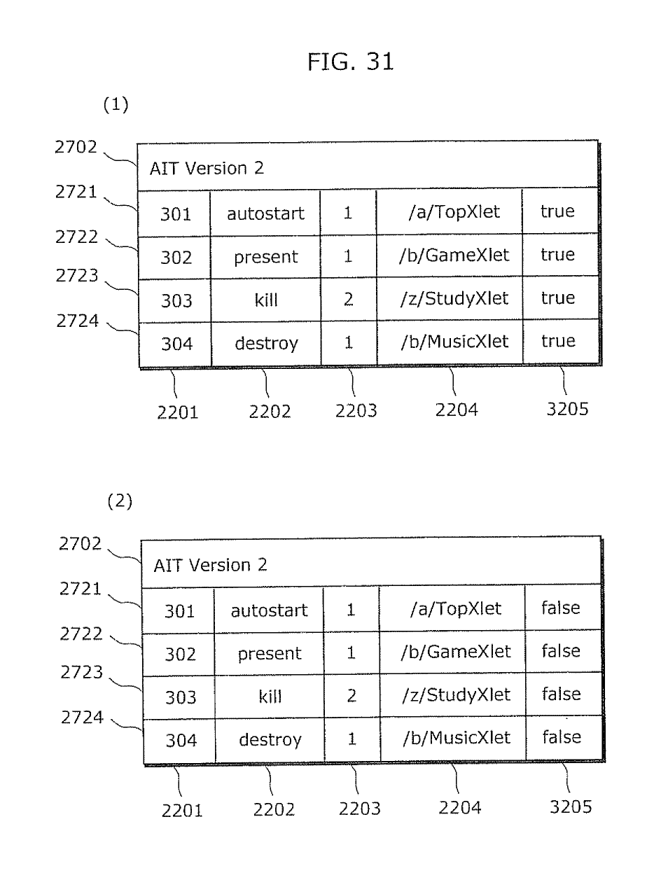

Thus, through the operation as described above, in the case of the AIT(1) as shown in FIG. 31, for example, the activation and termination of the Java program is performed based on all the control information, irrespective of whether the service is being reproduced in a trick play mode or in a normal play mode.

In an another example of receiving the AIT(2) as the AIT which is updated during the normal play operation, only the Java program (Java program identifier=301) of the row 2721 is activated. After that, when the reproduction in the trick play mode is started by calling “setRate()” with the value other than factor=1.0, the Java program (Java program identifier=301) of the row 2721 is killed.

When the AIT(2) is received during the reproduction in the trick play mode, the Java program is not executed.

Thus, according to the present embodiment, in the case where the Java program is terminated due to the start of the reproduction of the service in the trick play mode, the use if informed of the status so that the user can know the presence of the Java program which should normally be executed and apply the method of returning the trick play mode back to the normal play mode. Thus, it is possible to prevent the Java program from being not executed.

### Second Embodiment

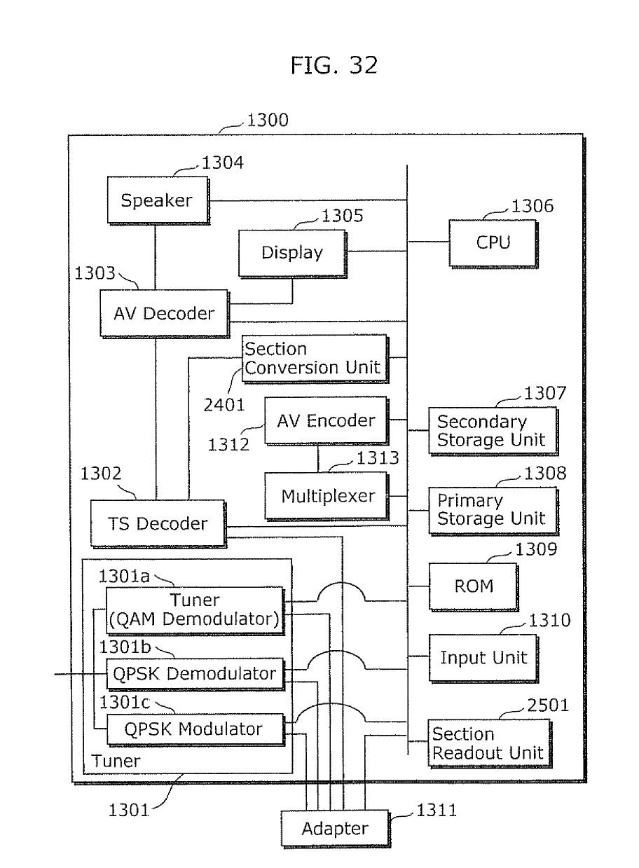

FIG. 32 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is the broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; a multiplexer (MPEG-2 Transport Stream Multiplexer or the like) 1313, a section conversion unit 2401, and a section readout unit 2501. The constituent elements aside from the multiplexer 1313, the section conversion unit 2401, and the section readout unit 2501 are the same as the constituent elements with the same referential numbers shown in FIG. 13, therefore, descriptions are omitted.

The multiplexer 1313 differs from that described in the first embodiment in that the former does not multiplex AIT sections and DSMCC sections. Aside from that, they are the same.

The section conversion unit 2401 records the section which has not been multiplexed by a multiplexer into the recording area 1504 of the secondary storage unit 1307. The AIT sections and the DSMCC sections which have been filtered by the TS decoder 1302 are recorded into the recording area 1504 through the section conversion unit 2401 without going through the multiplexer after passing through the primary storage unit 1308. The recording of the section into the recording area 1504 differs depending on the format of the section.

In the case of a file system recorded into an MPEG-2 transport stream in a DSMCC file system, the file system is converted into a file system format unique to the recording area 1504, which is in turn unique to a terminal, and records the file system into the recording area 1504.

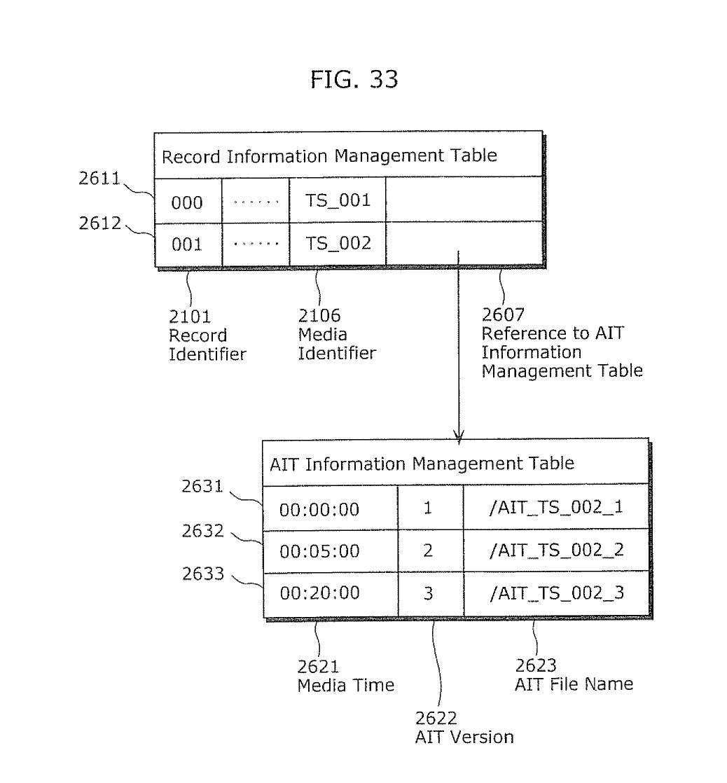

In addition, with regard to an AIT, the section conversion unit 2401 converts the AIT into a format of an expanded record information management table, as in FIG. 33, and records the AIT into the recording area 1504. The record information management table shown in FIG. 33 is an expanded version of the record information management table shown in FIG. 23; items identified with the same numbers in both tables have the same meaning as those in the record information management table shown in FIG. 23. The descriptions are therefore omitted. Each of rows 2611 and 2612 shows record information of one service. Each of the rows 2611, 2612 has a record identifier 2101, a channel identifier 2102, a program number 2103, a service record start time 2104, a service record end time 2105, a media identifier 2106, and a reference to an AIT information management table. The AIT information management table has a media time 2621 and an AIT version 2622 corresponding thereto. The media time 2621 is the time at the time of reproduction of the corresponding MPEG-2 transport stream, and shows a position in the corresponding MPEG-2 transport stream. The AIT version number 2622 corresponds to an AIT version number 2200 in FIG. 21. For example, record information of the service that has “001” as a record identifier 2101 has “TS_{—}002” as a media identifier 2106, and when the media time 2621 indicates “00:00:00” in the referred AIT information management table, the corresponding AIT version number 2622 is “1”. In the same manner, when the media time 2621 indicates “00:05:00”, the corresponding AIT version number 2622 is “2”, and when the media time 2621 indicates “00:20:00”, the corresponding AIT version number 2622 is “3”.

For example, at the time of the reproduction of the service that has “001” as a channel identifier 2601, referring to the record information management table, the MPEG-2 transport stream that is multiplexed with the video and audio specified by the media identifier 2602 of “TS_{—}002” is reproduced; in addition, referring to the AIT information management table, when the media time 2621 reaches “00:00:00”, control which causes the Java program to start up or terminate is performed in accordance with the AIT with an AIT version number 2622 of “1”. In a similar manner, the control which causes the Java program to start up or terminate is performed in accordance with the AIT with an AIT version number 2622 of “2” when the media time 2621 reaches “00:05:00”, and in accordance with the AIT with an AIT version number 2622 of “3” when the media time 2621 reaches “00:20:00”. The actual AIT is converted, as a binary file in private section format, into the file system format unique to the recording area 1504, which is in turn unique to a terminal, and is recorded into the recording area 1504. The recorded file is given a unique file name by which it can be uniquely identified, and which is recorded in the record information administration table as an AIT file name 2623.

In an actual broadcast wave, AITs with the same AIT version are repeatedly transmitted any number of times, but in the present embodiment, by detecting a change in the received AIT version, only the first AIT that is updated at that point in time is recorded into the recording area 1504.

The section readout unit 2501 searches for the media time corresponding to the current playback time of the MPEG-2 transport stream which is read out from the recording area, reads out the AIT and the DSMCC file corresponding to the media time from the file, and passes them to the AIT monitoring unit. In other words, the AIT monitoring unit 3201 does not refer to the filtering result of the TS decoder as shown in the first embodiment, but obtains the AIT binary file and the DSMCC file system from the section readout unit 2501.

The following describes in detail the operation used by the broadcast recording and reproduction apparatus as described above in recording the service contained in a broadcast wave into the secondary storage unit 1307 and reproducing the service by sequentially reading out the service from the secondary storage unit 1307.

First, the operation of recording the service included in a broadcast wave is described below.

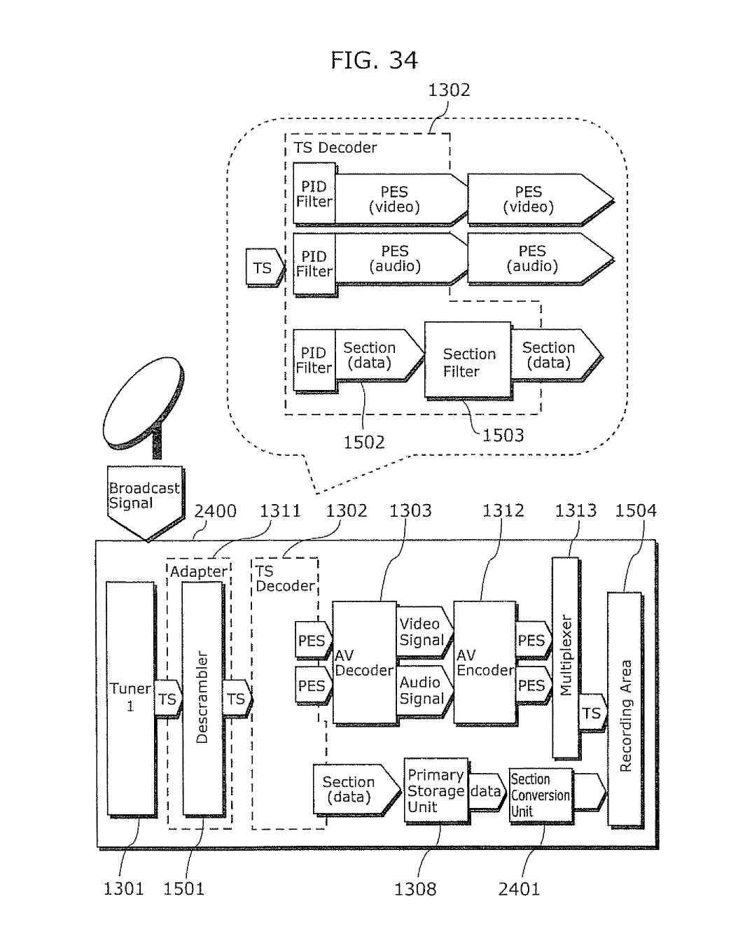

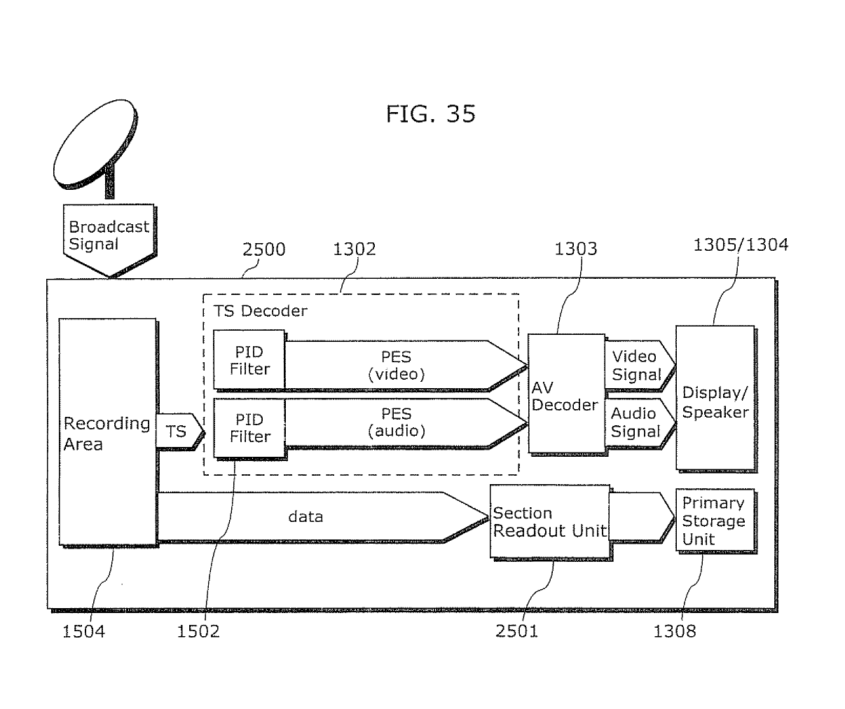

FIG. 34 shows a conceptual rendering which represents the physical connection sequence, processing details, and input/output data format of each device during the recording of the service. Constituent elements in the diagram that have identical numbers to the constituent elements shown in FIG. 16 have already been described in the first embodiment, and therefore descriptions are omitted. The hardware configuration shown in FIG. 34 differs from that in FIG. 16 in that the AIT section and the DSMCC sections which have been filtered by the TS decoder 1302 are recorded into the recording area 1504 via the section conversion unit 2401 without going through the multiplexer after passing through the primary storage unit 1308.

Next, the operation of reproducing the service by reading out the service from the MPEG-2 transport stream recorded in the secondary storage unit 1307 will be described.

FIG. 35 shows a conceptual rendering which represents the physical connection sequence, processing details, and input/output data format of each device during the reproduction of the service. Constituent elements in the diagram that have identical numbers to the constituent elements shown in FIG. 17 have already been described in the first embodiment, and therefore descriptions are omitted.

The hardware configuration shown in FIG. 35 differs from that shown in FIG. 17 in that the section recorded in the recording area 1504 is read into the primary storage via the section readout unit 2501 without going through the TS decoder.

Thus far, an example of a hardware configuration regarding the present invention has been described. Hereafter, a chief function of the present invention, which is control of recording the service and control of trick play via a Java program, is described.

The structure of the program necessary for the recording and reproduction of the service is the same as that shown in FIGS. 18 and 20 used in the first embodiment, and is software stored in the ROM 1309. The constituent elements other than the AM 1704a shown in the diagram have the same function as those described in the first embodiment, therefore, descriptions are omitted.

The AM 1704b has the internal structure as shown in FIG. 20, as in the first embodiment. The AIT monitoring unit 3201 differs in that it reads out the AIT file separately recorded in the secondary storage unit, instead of obtaining, through filtering, the AIT multiplexed with the MPEG-2 transport stream which is read out from the secondary storage unit 1307. The AIT monitoring unit 3201 verifies the AIT of the current media time with the media time 2621 within the AIT information management table, obtains the AIT file name corresponding to the current media time, and reads an actual AIT file. As the media time advances and the time to refer to another AIT is reached, the AIT monitoring unit 3201 reads out a new AIT. In other words, this is equivalent to update of the version of the AIT. Therefore, the valid time of the AIT of the current version shall be from a valid start media time of the AIT until the valid start media time of another AIT.

The application status management unit 3202 reads out the Java class file which is recorded in an original file system format into the secondary storage unit 1307, instead of reading out the reading-in of the Java program from the DSMCC section multiplexed with the MPEG-2 transport stream. The operation aside from that is as same as that of the application status management unit according to the first embodiment.

Here, the case of reproducing, from the recording area 1504 at the normal speed, the service corresponding to the channel identifier “001”, using the AIT shown in FIG. 21 and the record information management table shown in FIG. 33, is taken as an example.

When the service corresponding to the channel identifier “001” is specified as a service to be reproduced, each of the audio, video and Java program belonging to and the service are reproduced and activated, as already mentioned in the description regarding the reproduction of the service.

In the case where a media time to start the reproduction is not specified, the reproduction is commenced from the media time 2621 of “00:00:00”. In other words, as audio and video, the MPEG-2 transport stream, having a media identifier 2102 of “TS_{—}002”, corresponding to a record identifier 2101 of “001”, is reproduced from the media time 2621 of “00:00:00”. Referring to the AIT information management table, since the AIT version 2622 corresponding to the media time 2621 of “00:00:00” is “1”, the AIT with the AIT version 2200 of “1” is read out from the file. Based on the details of the AIT, the Java program corresponding to the program name 2204 having control information 2202 of “autostart” is activated.

Then, the reproduction of the service continues, and when the position, at which the MPEG-2 transport stream corresponding to the media identifier 3502 of “TS_{—}002” is being reproduced, indicates the media time 2621 of “00:05:00”, referring to the AIT information management table, since the AIT version number 2622 corresponding to the media time 2621 of “00:05:00” is “2”, the Java program corresponding to the program name 2204 having control information 2202 of “autostart” is activated, and also, the Java program corresponding to the program name 2204 having control information of “destroy” or “kill” is terminated, based on the AIT with the AIT version number 2200 of “2”. Here, referring to FIG. 21, the program name having control information 2202 of “destroy” is “/b/MusicXlet” and the program name having control information 2202 of “kill” is “/z/StudyXlet”, therefore, in the case where the Java programs corresponding to these program names are executed at the media time 2621 of “00:05:00”, those Java programs are terminated.

Then, the reproduction of the service continues, and when the position, at which the MPEG-2 transport stream corresponding to the media identifier 2106 of “TS_{—}002” is being reproduced, indicates the media time 2621 of “00:20:00”, referring to the AIT information management table, the AIT version number 2622 corresponding to the media time 2621 of “00:20:00” is “3”, therefore, the Java program corresponding to the program name 2204 having control information 2202 of “autostart” is activated, and also, the Java program corresponding to the program name 2204 having control information 2202 of “destroy” or “kill” is terminated, based on the AIT with the AIT version 2200 of “3”.

The operation characteristic to the broadcast recording and reproduction apparatus with the configuration described above can be described referring to the same flowchart as used in the first embodiment.

FIG. 27 is a flowchart showing an example of the operation of recording a service. FIGS. 28, 29 and 30 are flowcharts showing an example of the operation for reproducing the service recorded in MPEG-2 transport stream format in the secondary storage unit. Either of them is as same as the one used in the first embodiment, therefore, descriptions are omitted.

Thus, through the operation as described above, with the AIT (1) as shown in FIG. 31, the activation and termination of the Java program is performed based on all the control information irrespective of whether the service is being reproduced in a trick play mode or in a normal play mode.

As another example, when AIT (2) is received as the AIT updated during the normal play operation, only the Java program (Java program identifier=301) of the row 2721 is activated. After that, when the reproduction in the trick play mode starts after “setRate()” is called with a value other than factor−1.0, the Java program (Java program identifier=301) of the row 2721 is killed.

When AIT(2) is received during the reproduction in the trick play mode, the Java program is not executed.

Thus, according to the present embodiment, in the case where the Java program is terminated due to the start of the reproduction in the trick play mode, the user is informed of the status so that the user can know the Java program to be originally executed, and it is possible to take the method of returning back to the normal play operation or the like, and thus the Java program can be prevented from not being executed.

### Third Embodiment

Some of the embodiments described above indicate embodiments of the present invention, but other embodiments can be considered without deviating from the scope of the present invention.

In the embodiments, a configuration for a cable system has been shown, but the present invention can be applied independent of the type of broadcast system. For example, the present invention can easily be applied to a satellite system, a ground wave system, or a TV show distribution system that uses an IP network. In addition, as the present invention has no direct relationship with the differences between each broadcast system, the present invention can be applied to an arbitrary transmission medium regardless of the broadcast system. The present invention is also applicable regardless of whether the system is a wired or wireless system.

It is not necessary for the AV decoder to decode video and audio at the same time. The present invention can be implemented even if the AV decoder is configured as separate video and audio decoders. In addition, the AV decoder may have a decode function for data such as closed captioning and the like without any interference. The audio signal and video signal decoded by the AV decoder may be encrypted at any stage up until being stored in the recording area 1504.

In the embodiments, an example is given in which an adapter that controls conditional access system has been introduced, but the adapter is not necessary for the implementation of the present invention. The adapter may be of any format, and a configuration without the adapter is also possible. In such a case, in FIG. 16, the MPEG-2 transport stream from the tuner is inputted directly into the TS decoder. The present invention is applicable is such a case as well. In addition, descrambling the MPEG-2 transport stream by the adapter does not necessarily have to be carried out before the TS decoder. A configuration in which the adapter is in an arbitrary position and is used to descramble the MPEG-2 transport stream is easily implementable, and the present invention is applicable in such a case as well.

Regarding an encoding format into which the AV encoder encodes the audio and video signal, an arbitrary format is acceptable. The present invention is applicable regardless of the encoding format.

A multiplexing format of the multiplexer may also be an arbitrary format. The present invention is applicable regardless of the multiplexing format.

The display and the speaker may be contained within the broadcast recording and reproduction apparatus, or an external display and speaker may be connected to the broadcast recording and reproduction apparatus. The present invention is applicable regardless of the location and number of the display and speaker.

The present invention can be implemented even if the CPU itself is a system which performs multiple processes, the processes being all or some of TS decoding, AV decoding, AV encoding, and multiplexing.

As a format for recording the service, the MPEG-2 transport stream can also be recorded directly into the recording area after being outputted from the tuner, without going through the TS decoder; or, the format of the MPEG-2 transport stream from the tuner can be converted, by installing a translator that converts the format of the MPEG-2 transport stream, and recorded into the recording area. The present invention can be implemented regardless of the service recording method.

Some of the Java virtual machines translate the bytecode into an executable form which can be interpreted by the CPU, and pass the resultant to the CPU which executes it; the present invention is applicable in such case as well.

The above embodiments describe a method for implementation regarding the AIT in which the transport stream is obtained from in-band; however, the method for referring to the Java program which the AM shall execute does not solely depend on the AIT. In the OCAP which is assumed to be used in the US cable system, XAIT which describes reference information of an application program is utilized in the OOB shown in FIG. 3. In addition, methods such as starting a program pre-recorded in the ROM, starting a program downloaded and recorded in the secondary storage unit, and so on can be considered.

Note that the first and second embodiments show that, with the setting of a trick play compliant flag by expanding an AIT, whether the corresponding Java program is trick-play compliant is shown. However, it may be shown by other method.

In the present embodiment, a Java program is applied as a program for instructing for reproduction in the trick play mode, however, the present invention is applicable even to the case where a program which is not a Java program gives such instruction.

The format for recording a DSMCC file system and an AIT file may be arbitrary.

The present invention is implementable even by combining the method of obtaining, from the MPEG-2 transport stream, an AIT section through filtering, and the method of recording, into a file, a DSMCC section in an original format. The present invention is also implementable even by combining the method of obtaining, from the MPEG-2 transport stream, a DSMCC section through filtering, and the method of recording, into a file, an AIT section in an original format.

In the embodiments, both the Java program suspension display unit 3104 and a privilege handler manager are implemented; however, either of them may be implemented. In addition, the privilege handler manager is realized with a call back of handler program codes, but the manager may be realized through event notification instead. For the registration of a privileged handler, a configuration which requires some kind of authentication or permission may be applied. For example, the configuration may request a permission request file as defined by the DVB-MHP specification and OCAP specification.

The embodiments describe the configuration of sequentially calling both methods of “setPosition (start time of AIT) and “setRate(1.0)” which are held by the JMF, for reproducing the service from the start time of the AIT at the normal speed. However, a new method incorporating the two methods may be newly set as an API. For example, when a method such as “rewind()” is called, both of the methods “setposition (start time of AIT)” and “setRate(1.0)” are sequentially and internally executed. Or, it is possible to have a configuration which defines a return value of a call back method “notify()” of a privileged handler as “boolean” and reproduces the service from the start time of the AIT at the normal speed in the case of “true”.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

In the case where a program to be executed in synchronization with video and audio is not executed during the reproduction, in a trick play mode, of a service which includes such program, it is possible, with the broadcast recording and reproduction apparatus and broadcast recording and reproduction method according to the present invention, to prevent the program from being overlooked by the user, by providing a system for notifying the viewer that the program is not executed since the service is being reproduced in a trick play mode, and also a system for reproducing such service from the start time of the program in the skip-to-start operation. Therefore, there is a high possibility that the present invention is particularly used in a consumer appliance industry with regard to the broadcast recording and reproduction apparatus. For example, the present invention is useful as a cable STB and a digital TV or the like. Moreover, the present invention is also applicable in a device such as a cellular phone, providing that the device is equipped with a broadcast receiving function.

What is claimed is:

1. A broadcast recording and reproduction apparatus which receives a broadcast wave, and records and reproduces the received broadcast wave, the broadcast wave including one or more video information and audio information, one or more applications and application control information including information for executing the one or more applications in synchronization with reproduction of the one or more video information and audio information, and information indicating whether or not to execute the one or more applications in synchronization with trick play of the video information and the audio information, said apparatus comprising:
a receiving unit operable to receive the broadcast wave;
a recording unit operable to record, into a recording area, the one or more video information and audio information, the one or more applications and the application control information which are included in the received broadcast wave;
a video and audio reproduction unit operable to reproduce the video information and audio information recorded in the recording area;
an application control unit operable to control execution and termination of the application recorded in the recording area, in synchronization with the reproduction of the video information and the audio information, according to the application control information included in the broadcast wave recorded in the recording area;
an accepting unit operable to accept an instruction for trick play of the video information and audio information to be reproduced by said video and audio reproduction unit;
an in-trick-play application control determination unit operable to
judge whether or not the application to be executed in synchronization with the video information and audio information to be reproduced is to be executed during the trick play, based on the application control information, in the case where the trick play of the video information and audio information to be reproduced by said video and audio reproduction unit is detected,
determine to continue the execution of the application in the case of judging that the application is to be executed during the trick play, and
determine to terminate the execution of the application in the case of judging that the application is not to be executed during the trick play; and
an application presence notification unit operable to notify a user of a message indicating that there is an application which is judged not to be executed during the trick play,
wherein in the case where the trick play of the video information and audio information to be reproduced by said video and audio reproduction unit is detected, said application control unit is operable to control the execution of the application in accordance with the determination made by said in-trick-play application control determination unit, and
said application presence notification unit is operable to notify the user of a message indicating that there is an application which is judged not to be executed during the trick play.

2. The broadcast recording and reproduction apparatus according to claim 1,
wherein the application control information further includes application valid range information indicating a time during which the application is to be executed in synchronization with the video information and the audio information,
wherein said broadcast recording and reproduction apparatus further comprises
an application valid range detection unit operable to detect, during the reproduction or the trick play of the video information and audio information recorded in the recording area, whether or not a time has come to start executing the application, based on the application valid range information,
wherein said in-trick-play application control determination unit is further operable to
judge whether or not the application is to be executed during the trick play, based on the application control information, in the case where said application valid range detection unit detects that to the time has come to start executing the application during the trick play of the video information and audio information recorded in the recording area,
determine to start the execution of the application in the case of judging that the application is to be executed during the trick play, and
determine not to execute the application in the case of judging that the application is not to be executed during the trick play.

3. The broadcast recording and reproduction apparatus according to claim 1,
wherein the application control information further includes application valid range information indicating a valid range which is a time during which the application is to be executed in synchronization with the video information and audio information, and
said application presence notification unit is further operable to end the notification to the user when the valid range of the application which is determined to be terminated has come to an end.

4. The broadcast recording and reproduction apparatus according to claim 2,
wherein said application presence notification unit is further operable to end the notification to the user when the valid range of the application which is determined to be terminated has come to an end.

5. The broadcast recording and reproduction apparatus according to claim 1,
wherein the application control information further includes application valid range information indicating a valid range which is a time during which the application is to be executed in synchronization with the video information and the audio information,
said application presence notification unit is operable to notify the user of a message inquiring whether or not to execute the application which is judged not to be executed during the trick play operation, from a start point of the valid range of the application;
said broadcast recording and reproduction apparatus further comprises a response obtainment unit operable to obtain a result of user's response to the message, and upon detecting the result, executes the application from the start point of the valid range of the application and reproduces the video information and audio information from the start point in synchronization with the execution of the application, when it is detected that the result obtained as the user's response to the message indicates the execution of the application from the start point of the valid range of the application.

6. The broadcast recording and reproducing apparatus according to claim 2,
wherein said application presence notification unit is operable to notify of a message inquiring whether or not the application which is judged not to be executed during the trick play is to be executed from the start point of the valid range of the application,
said broadcast recording and reproduction apparatus further comprises a response obtainment unit operable to obtain a result of user's response to the message, and upon detecting the result, executes the application from the start time of the valid range of the application and reproduces the video information and audio information from the start time in synchronization with the execution of the application, when it is detected that the result obtained as the user's response to the message indicates the execution of the application from the start point of the valid range of the application.

7. The broadcast recording and reproduction apparatus according to claim 1,
wherein said application presence notification unit is operable to display the message to the user upon the execution of the application included in the broadcast wave.

8. The broadcast recording and reproduction apparatus according to claim 2,
wherein said application presence notification unit is operable to display the message to the user upon the execution of the application included in the broadcast wave.

9. The broadcast recording and reproduction apparatus according to claim 5,
wherein said application presence notification unit is operable to display the message to the user upon the execution of the application included in the broadcast wave.

10. The broadcast recording and reproduction apparatus according to claim 6,
wherein said application presence notification unit is operable to display the message to the user upon the execution of the application included in the broadcast wave,
said response obtainment unit is operable to obtain the result of user's response upon the execution of the application included in the broadcast wave.

11. A method for receiving a broadcast wave, and recording and reproducing the received broadcast wave, the broadcast wave including one or more video information and audio information, one or more applications and application control information including information for executing the one or more applications in synchronization with reproduction of the one or more video information and audio information, and information indicating whether or not to execute the one or more applications in synchronization with trick play of the video information and the audio information, said method comprising:
a receiving step of receiving the broadcast wave;
a recording step of recording, into a recording area, the one or more video information and audio information, the one or more applications and the application control information which are included in the received broadcast wave;
a video audio reproduction step of reproducing the video information and the audio information which are recorded in the recording area;
an application control step of control execution and termination of the application recorded in the recording area in synchronization with the reproduction of the video information and the audio information, according to the application control information included in the broadcast wave recorded in the recording area;
an accepting step of accepting an instruction for trick play of the video information and audio information to be reproduced by said video and audio reproduction unit;
an in-trick-play application control determination step of judging whether or not the application to be executed in synchronization with the video information and audio information to be reproduced is to be executed during the trick play based on the application control information, in the case where the trick play of the video information and audio information to be reproduced by said video and audio reproduction unit is detected,
determining to continue the execution of the application in the case of judging that the application is to be executed during the trick play, and to terminate the execution of the application in the case of judging that the application is not to be executed during the trick play; and
an application presence notification step of notifying a user of a message indicating that there is an application which is judged not to be executed during the trick play,
wherein in the case where the trick play of the video information and audio information to be reproduced by said video and audio reproduction unit is detected, in said application control step, the execution of the application is controlled in accordance with the determination made by said in-trick-play application control determination, and
in said application presence notification step, the user is notified of a message indicating that there is an application which is judged not to be executed during the trick play.

12. A program for a broadcast recording and reproduction apparatus which receives a broadcast waves and records and reproduces the received broadcast wave, the broadcast wave including one or more video information and audio information, one or more applications and application control information including information for executing the one or more applications in synchronization with reproduction of the one or more video information and audio information, and information indicating whether or not to execute the one or more applications in synchronization with trick play of the video information and the audio information, said program causing a computer to execute the steps included in the broadcast recording and reproduction method according to claim 11.
